(19) United States
(12) Patent Application Publication
(10) Pub. No.: US 2002/0197520 A1
(43) Pub. Date: Dec. 26, 2002

(54) Micro fuel cell array

(75) Inventors: Nathaniel R. Quick, Lake Mary, FL (US); Michael Liberman, Deland, FL (US); Michael C. Murray, Eustis, FL (US)

Correspondence Address: KNOBBE MARTENS OLSON & BEAR LLP, 2040 MAIN STREET, FOURTEENTH FLOOR, IRVINE, CA, 92614, US

(73) Assignee: USF Filtration & Separations Group., Inc, Timonium, FL (US)

(21) Appl. No.: 10/006,186

(22) Filed: Dec. 10, 2001

Related U.S. Application Data
(60) Provisional application No. 60/301,014, filed on Jun. 25, 2001.

(51) Int. Cl. H01M 8/12; H01M 8/24; H01M 4/92; B05D 5/12

(52) U.S. Cl. 429/32; 429/31; 429/34; 429/44; 427/115

(57) ABSTRACT

A micro fuel cell array and method of making is disclosed for providing electrical power to an electrical load upon flow of a first and a second gas. The micro fuel cell array comprises an array of the fuel cell elements each comprising a first electrode element surrounded by a second electrode element with an electrolyte interposed therebetween. The array is drawn for miniaturizing the array and for electrically interconnecting the second electrode elements to form a second fuel cell electrode for connection to the electrical load. The first fuel cell elements are interconnected by a first electrode element for connection to the electrical load.

### CROSS-REFERENCE TO RELATED APPLICATIONS

This application claims benefit of U.S. Patent Provisional application serial No. 60/301,014 filed Jun. 25, 2001. All subject matter set forth in provisional application serial No. 60/301,014 is hereby incorporated by reference into the present application as if fully set forth herein.

### BACKGROUND OF THE INVENTION

1. Field of the Invention

This invention relates to fuel cells and more particularly to the improved micro fuel cell array and the method of making.

2. Background of the Invention

The world need for electrical energy and the absolute need to preserve the environment are goals in opposition when considering conventional electrical energy production facilities. Many of the perceived clean energy generation methods such as wind power, solar and hydroelectric produce negative environmental effects, including noise and alterations to the topography and terrain.

Fuel cells provide a common solution to the opposed goals of electrical energy and environment. In a fuel cell, chemical energy is converted directly into electrical power by means of electrochemical reactions. The production of electrical power in a fuel cell by direct conversion of fuel into electrical energy results in high conversion efficiencies.

Fuel cells are inherently highly efficient devices. Fuel cells have been able to convert fuel to useful electrical energy at efficiencies in excess of 60 percent. In addition to this high efficiency, fuel cells produce electrical energy with substantially no adverse by-products. Since fuel cells are substantially silent during operation, their physical placement during operation is not critical to maintaining a noise free environment.

The development of large fuel cells has progressed at a rapid rate and the appearance of large fuel cells in the retail marketplace is expected within the next few years. Solid oxide fuel cell (SOFC) systems in excess of 100 kilowatts have demonstrated dependable performance for thousands of hours. Expectations of commercial production of SOFC units in the 250 to 1000 kilowatt range are expected within the next few years.

A fuel cell comprises an anode electrode and a cathode electrode with each electrode including a catalytic agent. The anode electrode and cathode electrode are separated by an electrolyte. The electrolyte conducts specific ions and simultaneously acts as an insulator for electron flow. The electrolyte may be a solid or a liquid. Further, the electrolyte must be able to prevent mixing of the fuel applied to the electrodes.

In one configuration, hydrogen passing over the anode is oxidized, producing a hydrogen ion and releasing an electron. The positive hydrogen ions migrate through the electrolyte toward the cathode and react with oxygen to form water. In another configuration, oxygen ions are produced which migrate through the electrolyte to the anode to react with hydrogen. A conductor interconnecting the anode and cathode completes the electrical circuit through an electrical load. The electrons released at the anode flow through the conductor and the electrical load to the cathode. Additionally, fuel and oxidizer storage, delivery and control systems must be provided for an operational fuel cell system.

The operation of fuel cells, as is the case with other electrochemical systems, is temperature dependent. The chemical activity of the reactants and catalysts and the electrical output is reduced by low temperature. Increasing the reactivity by increasing the fuel cell temperature introduces new problems for the practitioner. The increased temperature may reduce the useful life of electrodes and other components of the fuel cell system. Both thermal and chemical reactivity concerns must be addressed in the design and development of fuel cell systems.

Fuel cell designs are generally in one of three categories: planar, monolithic, or tubular geometries. In planar geometry fuel cells, two thin flat plates are sealed to each other. The plates are ribbed to create gas flow channels therebetween. The electrolyte and electrical interconnections are fabricated by powder sintering or chemical vapor deposition. The porous electrodes are applied via slurry methods, screen printing or plasma spraying. One significant problem associated with planar geometry fuel cells is the formation of the seals that must withstand relatively high temperatures.

Monolithic geometry fuel cells comprise a stack of thin layer components forming an array of cells similar to a honeycomb. In this configuration, fuel and oxidant occupy adjacent channels. The monolithic fuel cells are sealed by high temperature sintering processes.

Tubular geometry fuel cells have shown great promise and have seen the most progress in recent years. In tubular geometry fuel cells, the electrolyte and the anode fuel components are deposited on a tubular oxygen electrode forming the cathode. The electrolyte is deposited on the cathode. Thereafter the anode is formed around the electrolyte. The oxygen flow is directed to flow through the cathode and a gas fuel is directed to flow around the anode.

Since many of the technological problems involved in the development of large fuel cells have been solved, much research is being directed to the development of a micro fuel cell. Small electrically powered devices, such as cellular telephones, pagers and laptop computers, with limited battery life between recharging are good examples of the established need for micro fuel cells. The same principles of design, fabrication and operation effecting large fuel cells are applicable in micro fuel cell technology, but with the additional complication of micro-fabrication. In these applications, power to weight and power to volume ratios become critical considerations. Temperature vs. reactivity considerations must also be addressed during the development of micro fuel cells. The following patents are representative of the developments of the prior art in an attempt to reduce the size of fuel cells suitable for portable operation.

U.S. Pat. No. 4,294,891 to YAO et al discloses an implantable biologically acceptable miniature fuel cell that is intermittently refuelable through one or more percutaneously positioned refueling ports. Refueling occurs by injection, preferably by hypodermic, typically annually. No transcutaneous leads or refueling stoma or tubes are employed. The cell is a bio-oxidant cell, as distinct from being a bioautofuel cell, having a silicone membrane coating over at least one external cathode surface permitting oxygen and water molecules to diffuse therethrough while preventing exit of organic fuel or oxidation-reduction by-products. Carbohydrate fuels are disclosed with glycerol being preferred from among it, glucose, sorbitol and mixtures. A variety of cathode and anode compositions are disclosed with Pt-black anodes and carbon-black cathodes being preferred. A high fuel to O₂ concentration ratio is important to prevent O₂-parasitic effect on the anode. A high IS buffer is employed as the electrolyte, in the range of above 0.2 M, preferably 0.3-1.0 M, with a pH of above about 6.0, preferably 7.0-7.8. The cells produce approximately 0.14 watt-hr/gm and 0.16 watt-hr/ml, have operated satisfactorily in vitro for 225 days without refueling and are still running, 458 days with refueling, and satisfactorily in vivo for 55 days in baboon subjects without refueling.

U.S. Pat. No. 5,641,585 to Paul A. Lessing and Anthony C. Zuppero discloses a miniature power source assembly capable of providing portable electricity. A preferred embodiment of the power source assembly employing a fuel tank, fuel pump and control, air pump, heat management system, power chamber, power conditioning and power storage is disclosed. The power chamber utilizes a ceramic fuel cell to produce the electricity. Incoming hydrocarbon fuel is automatically reformed within the power chamber. Electrochemical combustion of hydrogen then produces electricity.

U.S. Pat. No. 5,759,712 to Hockaday discloses a miniature fuel cell system using porous plastic membranes as substrates of fuel cells. A cost effective pore-free electrode or inter electrolyte foil that is permeable only to hydrogen as an ion is disclosed. The new electrode makes direct alcohol fuel cells efficient. It blocks the poisoning alcohol diffusion through the electrolyte. Compound electrodes are formed by vacuum deposition methods and slurries. That leads to printed circuit designs of small fuel cells systems integrated with rechargeable batteries and electrical power electronics to power applications that are currently powered by batteries. By directly utilizing alcohol fuels the new fuel cells have higher energy per unit mass and higher energy per unit volume. They are more convenient for the energy user and environmentally less harmful and less expensive than conventional batteries.

U.S. Pat. No. 6,057,051 to Makoto Uchida et al discloses a miniaturized fuel cell assembly to power portable electronic equipment including a hydride hydrogen storage unit, a control unit for controlling the flow of hydrogen, a hydrogen supply device interconnecting the hydrogen storage unit and the fuel cell body, and an air feed device to supply oxygen necessary for the generation of electricity. The fuel cell assembly may also have an air feed device to cool the interior of the equipment, including a water retention device for recovering and retaining water formed in the fuel cell body, and a humidifying device using the recovered water to humidify the hydrogen to be supplied to the fuel cell body. The miniaturized fuel cell assembly facilitates the effective transfer of waste heat from the fuel cell to the hydrogen storage unit, and as a result of its ability to be used repeatedly, can be utilized for a greater length of time than a conventional primary or secondary power cell.

U.S. Pat. No. 4,155,712 to Walter G. Taschek discloses a relatively small size apparatus for generating hydrogen by the reaction of a metal hydride with water vapor. The metal hydride utilized to generate the hydrogen gas is housed in a fuel chamber of the apparatus and water vapor is introduced into the fuel chamber through a porous membrane having selected characteristics. The metal hydride reacts with the water vapor in a conventional manner to produce pure hydrogen. A variable gas pressure and liquid pressure balance means for introduction of water vapor enables automatic hydrogen generation on demand and enables complete shut down when demand ceases. The apparatus of this invention may be operated at any selected constant pressure feed rate. Further, with the apparatus of this invention the water source is effectively isolated from the metal hydride by the porous membrane, which has hydrophobic characteristics, and as a consequence, both contamination of the water source and caking of the metal hydride fuel is minimized. The apparatus of this invention can be utilized as a hydrogen or other gas source in many applications where a source of hydrogen or other gas is required but is ideally suited for regulated and pressure feed applications, for example, as the hydrogen source for the hydrogen electrode of the fuel cell.

Although the aforementioned U.S patents have dramatically reduced the size of fuel cells, the need for smaller, more powerful micro fuel cells has not been satisfied.

Therefore, it is an object of the present invention to provide a micro fuel cell array that overcomes the deficiencies of the prior art and provides a significant advancement in the fuel cell art.

Another object of this invention is to provide a micro fuel cell array with a high power to weight ratio.

Another object of this invention is to provide a micro cell array comprising chemically and thermally resistive components.

The foregoing has outlined some of the more pertinent objects of the present invention. These objects should be construed as being merely illustrative of some of the more prominent features and applications of the invention. Many other beneficial results can be obtained by applying the disclosed invention in a different manner or modifying the invention with in the scope of the invention. Accordingly other objects in a full understanding of the invention may be had by referring to the summary of the invention, the detailed description setting forth the preferred embodiment in addition to the scope of the invention defined by the claims taken in conjunction with the accompanying drawings.

### SUMMARY OF THE INVENTION

The present invention is defined by the appended claims with specific embodiments being shown in the attached drawings. For the purpose of summarizing the invention, the invention relates to a micro fuel cell array and method for making. The micro fuel cell array provides electrical power to an electrical load upon flow of a first and a second gas. The micro fuel cell array is formed from an array of fuel cell elements. Each of the fuel cell elements comprises a first electrode element surrounded by a second electrode element with an electrolyte material interposed therebetween. A first gas passageway proximate the first electrode element allows the first gas to flow therethrough and to interact with the first electrode element. A second gas passageway proximate the second electrode element allows the second gas to flow therethrough and to interact with the second electrode element. A first electrode element connector interconnects each of the first electrode elements to form a first fuel cell electrode for connection to an electrical load. A second electrode element connector interconnects each of the second electrode elements to form a second fuel cell electrode for connection to the electrical load.

In a more specific embodiment of the invention, each of the first electrode elements may comprise a tube which may be a gas permeable material containing metals such as platinum or silver. The electrolyte material may comprise a ceramic or glass material. The electrolyte material may be deposited on the first electrode material as a precursor material and later in the process reacted to become the electrolyte material. Each of the second electrode elements may comprise a tube which may be a gas permeable material containing metals such as platinum or palladium.

In a more specific embodiment of the invention, the first electrode element connector includes each of the first electrode elements having an exposed portion. The first electrode element connector interconnecting each of the exposed portions of each of the multiplicity of the first electrode elements forms the first fuel cell electrode for connection to the electrical load.

The second electrode element connector includes the multiplicity of fuel cell elements that may be disposed in a circular array being disposed within a casing. The casing is electrically conductive, and may include metallic tubes. The fuel cell elements are disposed in electrical contact with the casing for connection to the electrical load.

The invention is also incorporated into the process for making a micro fuel cell array comprising the steps of providing a multiplicity of fuel cell elements with each of the fuel cell elements comprising a first electrode element overlaid by a second electrode element with an electrolyte material interposed therebetween. The first fuel cell element is drawn for reducing the outer diameter thereof. A multiplicity of the fuel cell elements forms an array for encasing within a casing. The casing of the multiplicity of fuel cell elements therein is drawn for reducing the outer diameter thereof and for forming a fuel cell and for electrically interconnecting the multiplicity of second electrode elements to form a second fuel cell electrode for connection to the electrical load. The multiplicity of first electrode elements of the multiplicity of fuel cell elements are interconnected to form a first fuel cell electrode for connection to the electrical load.

In another example of the invention, the process for making a micro fuel cell array comprises the steps of providing a multiplicity of fuel cell elements with each of the fuel cell elements comprising a first electrode element overlaid by a second electrode element with an electrolyte forming material interposed therebetween. The first fuel cell element is drawn for reducing the outer diameter thereof. The multiplicity of fuel cell elements are encased within a casing. The casing with the multiplicity of fuel cell elements therein is drawn for reducing the outer diameter thereof, and for forming a fuel cell and for electrically interconnecting the multiplicity of second electrode elements to form a second fuel cell electrode for connection to the electrical load. The multiplicity of first electrode elements of the multiplicity of fuel cell elements are interconnected to form a first fuel cell electrode for connection to the electrical load.

The foregoing has outlined rather broadly the more pertinent and important features of the present invention in order that the detailed description that follows may be better understood so that the present contribution to the art can be more fully appreciated. Additional features of the invention will be described hereinafter which form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be made to the following detailed description taken in connection with the accompanying drawings in which:

FIG. 1 is a cut-away isometric view of a micro fuel cell array of the present invention;

FIG. 2 is a cut-away side elevational view of the fuel cell of FIG. 1;

FIG. 3 is an end view along line 3-3 of the fuel cell of FIG. 2;

FIG. 4 is a block diagram illustrating a first process of forming the micro fuel cell array of the present invention;

FIG. 5 is an isometric view of a first electrode element encasing a sacrificial material;

FIG. 5A is an end view of FIG. 5;

FIG. 6 is an isometric view of an electrolyte material covering the first electrode;

FIG. 6A is an end view of FIG. 6;

FIG. 7 is an isometric view of a second electrode element encasing the electrolyte material;

FIG. 7A is an end view of FIG. 7;

FIG. 8 is an isometric view after drawing the first and second electrode elements and the electrolyte material of FIG. 7 for forming a fuel cell element;

FIG. 8A is an end view of FIG. 8;

FIG. 9 illustrates an isometric view of an array of fuel cell elements of FIG. 8;

FIG. 9A is an end view of FIG. 9;

FIG. 10 is an isometric view of the array of fuel cell elements of FIG. 9 encased in a tube;

FIG. 10A is an end view of a FIG. 10;

FIG. 11 is an isometric view after drawing of the encased array of fuel cell elements of FIG. 10;

FIG. 11A is an end view of FIG. 11;

FIG. 12 is an isometric view of the severing of the drawn array of fuel cell elements to form individual fuel cells arrays;

FIG. 12A is an end view of FIG. 12;

FIG. 13 is an isometric view illustrating the removal of the sacrificial material from the individual fuel cells arrays of FIG. 12;

FIG. 13A is an enlarged isometric view of a single fuel cell array of FIG. 13;

FIG. 14 is an isometric view illustrating exposed first end of first electrodes of a plurality of fuel cell arrays;

FIG. 14A is an enlarged isometric view of a single fuel cell array of FIG. 14;

FIG. 15 is an isometric view illustrating exposed second end of first electrodes of a plurality of fuel cell arrays;

FIG. 15A is an enlarged isometric view of a single fuel cell array of FIG. 15;

FIG. 16 is an isometric view illustrating the installation of a first electrode insulator on each of the plurality of fuel cell arrays;

FIG. 16A is an enlarged isometric view of a single fuel cell array of FIG. 16;

FIG. 17 is a cut-away isometric view illustrating the installation of a second electrode connector on each of the plurality of fuel cell arrays;

FIG. 17A is an enlarged isometric view of a single fuel cell array of FIG. 17;

FIG. 18 is a cut-away isometric view illustrating the installation of a first electrode connector on each of the plurality of fuel cell arrays;

FIG. 18A is an enlarged isometric view of a single fuel cell array of FIG. 18;

FIG. 19 is a cut-away isometric view illustrating the installation of a second electrode insulator on each of the plurality of fuel cell arrays;

FIG. 19A is an enlarged isometric view of a single fuel cell of FIG. 19;

FIG. 20 is an isometric view illustrating the installation of a first and a second end cap and first and second gas inlets and outlets on the single fuel cell array;

FIG. 21 is a block diagram illustrating a second process of forming the micro fuel cell array of the present invention;

FIG. 22 is an isometric view of a first electrode element encasing a sacrificial material;

FIG. 22A is an end view of FIG. 22;

FIG. 23 is an isometric view of an electrolyte material covering the first electrode;

FIG. 23A is an end view of FIG. 23;

FIG. 24 is an isometric view of a second electrode element encasing the electrolyte material;

FIG. 24A is an end view of FIG. 24;

FIG. 25 is an isometric view of a second sacrificial material encasing the second electrode;

FIG. 25A is an end view of FIG. 25;

FIG. 26 is an isometric view after drawing the first and second electrode elements and the electrolyte material of FIG. 25 for forming a fuel cell element;

FIG. 26A is an end view of FIG. 26;

FIG. 27 illustrates an isometric view of an array of the fuel cell elements of FIG. 26;

FIG. 27A is an end view of FIG. 27;

FIG. 28 is an isometric view of the array of fuel cell elements of FIG. 27 encased in a tube;

FIG. 28A is an end view of a FIG. 28;

FIG. 29 is an isometric view after drawing of the encased array of fuel cell elements of FIG. 28;

FIG. 29A is an end view of FIG. 29;

FIG. 30 is an isometric view of the severing of the drawn array of fuel cell elements to form individual fuel cells arrays;

FIG. 30A is an end view of FIG. 30;

FIG. 31 is an isometric view illustrating the removal of the sacrificial material from the individual fuel cells arrays of FIG. 30;

FIG. 31A is an enlarged isometric view of a single fuel cell array of FIG. 31;

FIG. 32 is an isometric view illustrating exposed first electrodes of a plurality of fuel cell arrays;

FIG. 32A is an enlarged isometric view of a single fuel cell array of FIG. 32;

FIG. 33 is an isometric view illustrating the installation of a first electrode insulator;

FIG. 33A is an enlarged isometric view of a single fuel cell array of FIG. 33;

FIG. 34 is an isometric view illustrating the installation of a first electrode connector on each of the plurality of fuel cell arrays;

FIG. 34A is an enlarged isometric view of a single fuel cell array of FIG. 43;

FIG. 35 is an isometric view illustrating the array of fuel cell elements following removal of a second sacrificial material;

FIG. 35A is a partially cut-away enlarged isometric view of a single fuel cell array of FIG. 35;

FIG. 36 is an isometric view illustrating the installation of a second electrode connector on each of the plurality of fuel cell arrays;

FIG. 36A is a partially cut-away enlarged isometric view of a single fuel cell array of FIG. 536;

FIG. 37 is an isometric view illustrating the installation of a second electrode insulator on each of the plurality of fuel cell arrays;

FIG. 37A is a partially cut-away enlarged isometric view of a single fuel cell of FIG. 37;

FIG. 38 is an isometric view illustrating the installation of a first and a second end cap and first and second gas inlets and outlets on the single fuel cell array;

FIG. 39 is a block diagram illustrating a third process of forming the micro fuel cell array of the present invention;

FIG. 40 is an isometric view of a first electrode element encasing a sacrificial material;

FIG. 40A is an end view of FIG. 40;

FIG. 41 is an isometric view of an electrolyte material covering the first electrode;

FIG. 41A is an end view of FIG. 41;

FIG. 42 is an isometric view of a second electrode element encasing the electrolyte material;

FIG. 42A is an end view of FIG. 42;

FIG. 43 is an isometric view after drawing the first and second electrode elements and the electrolyte material of FIG. 42 for forming a fuel cell element;

FIG. 43A is an end view of FIG. 43;

FIG. 44 illustrates an isometric view of an array of fuel cell elements of FIG. 43 with a plurality of sacrificial materials located therebetween;

FIG. 44A is an end view of FIG. 44;

FIG. 45 is an isometric view of the array of fuel cell elements and the plurality of sacrificial material of FIG. 44 encased in a tube;

FIG. 45A is an end view of a FIG. 45;

FIG. 46 is an isometric view after drawing of the encased array of fuel cell elements of FIG. 45;

FIG. 46A is an end view of FIG. 46;

FIG. 47 is an isometric view of the severing of the drawn array of fuel cell elements to form individual fuel cells arrays;

FIG. 47A is an end view of FIG. 47;

FIG. 48 is an isometric view illustrating the removal of the sacrificial material from the individual fuel cells arrays of FIG. 47;

FIG. 48A is an enlarged isometric view of a single fuel cell array of FIG. 48;

FIG. 49 is an isometric view illustrating exposed first electrodes of a plurality of fuel cell arrays;

FIG. 49A is an enlarged isometric view of a single fuel cell array of FIG. 49;

FIG. 50 is an isometric view illustrating the installation of a first electrode insulator on each of the plurality of fuel cell arrays;

FIG. 50A is an enlarged isometric view of a single fuel cell array of FIG. 50;

FIG. 51 is an isometric view illustrating the installation of a first electrode connector on each of the plurality of fuel cell arrays;

FIG. 51A is an enlarged isometric view of a single fuel cell array of FIG. 50;

FIG. 52 is an exploded isometric view of a single fuel cell array of FIG. 51;

FIG. 53 is a partially cut-away isometric view illustrating the installation of a first end cap having a first and second gas inlet on the single fuel cell array;

FIG. 54 is a block diagram illustrating a fourth process of forming the micro fuel cell array of the present invention;

FIG. 55 is an isometric view of a first electrode element encasing a sacrificial material;

FIG. 55A is an end view of FIG. 55;

FIG. 56 is an isometric view of an electrolyte material covering the first electrode;

FIG. 56A is an end view of FIG. 56;

FIG. 57 is an isometric view of a second electrode element encasing the electrolyte material;

FIG. 57A is an end view of FIG. 57;

FIG. 58 is an isometric view after drawing the first and second electrode elements and the electrolyte material of FIG. 57 for forming a fuel cell element;

FIG. 58A is an end view of FIG. 58;

FIG. 59 illustrates an isometric view of a strand of fuel cell elements formed from a plurality of fuel cell elements of FIG. 58 disposed about a central sacrificial material;

FIG. 59A is an end view of FIG. 59;

FIG. 60 is an isometric view of the strand of fuel cell elements of FIG. 59 encased in a tube;

FIG. 60A is an end view of FIG. 60;

FIG. 61 is an isometric view after drawing of the strand of fuel cell elements of FIG. 60;

FIG. 61A is an end view of FIG. 61;

FIG. 62 illustrates an isometric view of an array of strands of fuel cell elements of FIG. 61;

FIG. 62A is an end view of FIG. 62;

FIG. 63 is an isometric view of the array of strands of fuel cell elements of FIG. 62 encased in a tube;

FIG. 63A is an enlarged end view of FIG. 63;

FIG. 64 is an isometric view after drawing of the array of strands of fuel cell elements of FIG. 63;

FIG. 64A is an enlarged end view of FIG. 64;

FIG. 65 is an isometric view of the severing of the drawn arrays of strands of fuel cell elements to form individual fuel cell arrays;

FIG. 65A is an end view of FIG. 65;

FIG. 66 is an isometric view illustrating the removal of the sacrificial material from the individual fuel cell arrays of FIG. 65; and

FIG. 66A is an enlarged isometric view of a single fuel cell array of FIG. 66.

Similar reference characters refer to similar parts throughout the several Figures of drawings.

Similar reference characters refer to similar parts throughout the several Figures of the drawings.

### DETAILED DISCUSSION

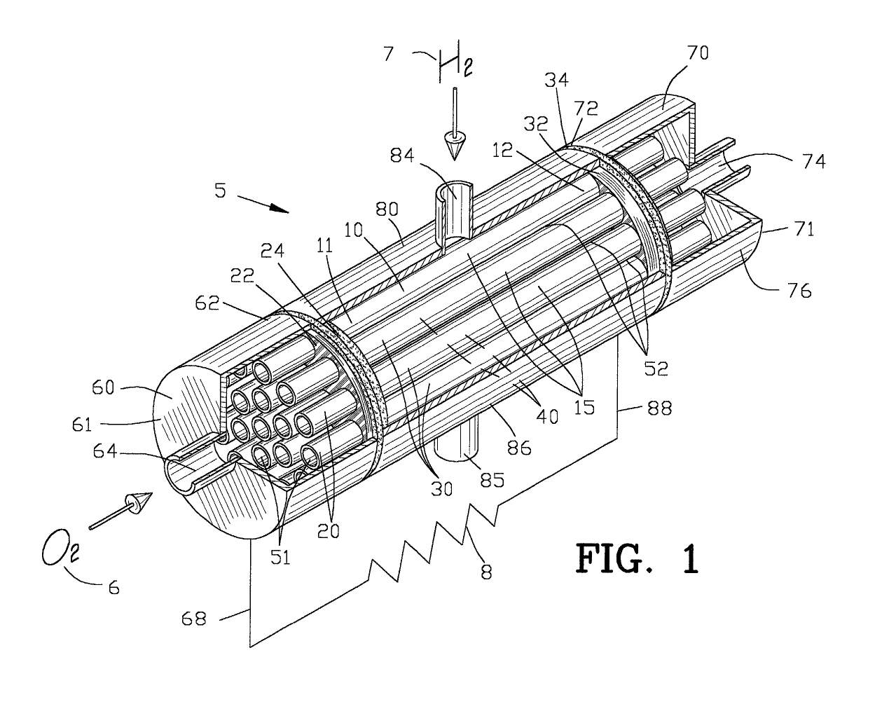

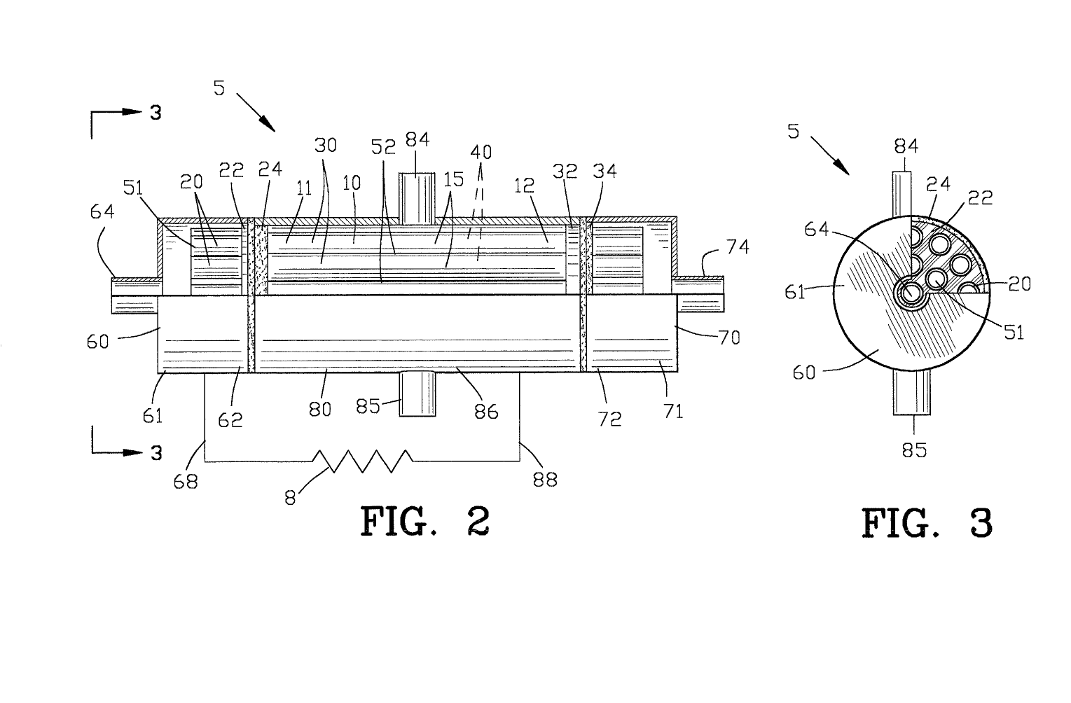

FIGS. 1-3 are various views of a micro fuel cell array 5 of the present invention. The micro fuel cell array 5 providing electrical power upon flow of a first gas 6 and a second gas 7. In this example of the invention, the micro fuel cell array 5 provides electrical power to an electrical load 8.

The micro fuel cell array 5 comprises a parallel generally cylindrical array 10 extending between a first and a second end 11 and 12. The cylindrical array 10 is formed from a multiplicity of fuel cell elements 15. Each of the fuel cell elements 15 comprises a first electrode element 20 and a second electrode element 30 with an electrolyte material 40 interposed between the first and second electrode elements 20 and 30. The structure and the method of making the fuel cell elements 15 will be explained in greater detail hereinafter.

A multiplicity of first gas passageways 51 are located in proximity to the multiplicity of the first electrode elements 20 for allowing the first gas 6 to interact with the first electrode elements 20. A multiplicity of second gas passageways 52 are located in proximity to the multiplicity of the second electrode elements 30 for allowing the second gas 7 to interact with the second electrode elements 30.

Each of the multiplicity of fuel cell elements 15 is shown as a tubular fuel cell element 15. The tubular fuel cell element 15 comprises the first electrode elements 20 shown as a tubular first electrode element 20, co-axially located second electrode element 30 and electrolyte 40 interposed therebetween. The tubular first electrode elements 20 define the first gas passageways 51 within the interior of each of the tubular first electrode elements 20.

The second electrode element 30 is coaxially located on the tubular first electrode element 20. The electrolyte material 40 is coaxially interposed between the first and second electrode elements 20 and 30. The second gas passageways 52 are defined as the interstices between the multiplicity of fuel cell elements 15.

A first electrode element connector 22 interconnects each of the multiplicity of first electrode elements 20 for connection to the electrical load 8. A second electrode element 5 connector 32 interconnects each of the multiplicity of second electrode elements 30 for connection to the electrical load 8. The flow of the first and second gases 6 and 7 through the first and second gas passageways 51 and 52 generates electrical power to the load 8.

In this example of the invention, the micro fuel cell array 5 comprises a first and a second endcap 60 and 70 with an intermediate casing 80 interposed therebetween. The first endcap 60 and the intermediate casing 80 are fabricated from electrically conductive materials. The second endcap 70 may be fabricated from an electrically conductive material or an electrically nonconductive material.

The first endcap 60 is shown as a substantially cylindrical endcap 60 extending from a closed end 61 to an open end 62. A first gas inlet port 64 is defined in the first endcap 60 for communicating with the first gas passageways 51 in proximity to the first end 11 of the cylindrical array 10. The first gas inlet port 64 enables the introduction of the first gas 6 to interact with the multiplicity of first electrode elements 20. In this example, the first gas 6 is shown as oxygen gas.

The first endcap 60 is affixed to the micro fuel cell array 5 by suitable means such as mechanical fastening, adhesive fastening, welding, soldering and the like. The first endcap 60 makes electrical contact with the first electrode element connector 22 for providing electrical contact between the multiplicity of the first electrode elements 20 and the load 8 through a first electrical conductor 68. The insulator 24 insulates the first electrode element connector 22 from the multiplicity of the second electrode elements 30 and the intermediate casing 80.

In a similar manner, the second endcap 70 is shown as a substantially cylindrical endcap 70 extending from a closed end 71 to an open end 72. A first gas outlet port 74 is defined in the second endcap 70 for communicating with the first gas passageways 51 in proximity to the second end 12 of the cylindrical array 10. The first gas outlet port 74 discharges any remaining quantities of the first gas 6 from the micro fuel cell array 5. Furthermore, the first gas outlet port 74 discharges any fuel cell reaction by products from the micro fuel cell array 5.

The second endcap 70 is affixed to the micro fuel cell array 5 in a manner similar to the first endcap 60. The second endcap 70 may be fabricated from either an electrically conductive material or an electrically non-conductive material. When the second endcap 70 is fabricated from an electrically conductive material, the insulator 34 insulates the second endcap 70 from the multiplicity of the second electrode elements 30 and the intermediate casing 80.

An intermediate casing 80 is shown as a substantially cylindrical casing 80 extending between a first end 11 and the second end 12. A second gas inlet port 84 is defined in the intermediate casing 80 for communicating with the second gas passageways 52 of the cylindrical array 10. The second gas inlet ports 84 enables the introduction of the second gas 7 to interact with the multiplicity of second electrode elements 30.

A second gas outlet port 85 is defined in the intermediate casing 80 for communicating with the second gas passageways 52 of the cylindrical array 10. The second gas outlet port 85 discharges any remaining quantities of the second gas 7 from the micro fuel cell array 5. In this example, the second gas 7 is shown as hydrogen gas.

The intermediate casing 80 is interposed between the first and second endcap 60 and 70. The intermediate casing 80 makes electrical contact with the second electrode element connector 32 for providing electrical contact between the multiplicity of the second electrode elements 30 and the load 8 through a second electrical conductor 88. The first and the second insulators 24 and 34 insulates the first and second ends 11 and 12 on the intermediate casing 80 from the multiplicity of first and second electrode elements 20 and 30.

The micro fuel cell array 5 of the present invention operates in a manner similar to conventional fuel cells known in the art. Although the micro fuel cell array 5 will be explained with reference to an oxygen gas 6 and a hydrogen gas 7 operation, it should be appreciated by those skilled in the art that the micro fuel cell array 5 of the present invention may be adapted for use with other types of fuels and fuel cell materials.

The first gas 6 shown as oxygen enters the first gas inlet port 64 of the first endcap 60 to flow into the multiplicity of first passageways 51 defined within the tubular first electrode elements 20. The first gas 6 enters the multiplicity of first passageways 51 to react with the first electrode elements 20 to perform a first half of the fuel cell reaction.

The second gas 7 shown as hydrogen enters the second gas inlet port 84 of the intermediate casing 80 to flow into the multiplicity of second passageways 52 defined as the interstices between the multiplicity of the fuel cell elements 15. The second gas 7 enters the second passageways 52 to react with the second electrode elements 30 to perform the second half of the fuel cell reaction.

Non-reacted quantities of the first gas 6 as well as fuel cell byproducts such as water are discharged from the first gas outlet port 74 defined in the second endcap 70. Typically, a constant flow of the first gas 6 will enter into the first gas inlet port 64 and exit from the first gas outlet port 74 as indicated by the arrow.

Non-reacted quantities of the second gas 7 are discharged from the second gas outlet port 85 defined in the intermediate casing 80. Typically, a constant flow of the second gas 7 will enter into the second gas inlet port 84 and exit from the second gas outlet port 85 as indicated by the arrow.

As the first and second gases 6 and 7 pass through the multiplicity of the first and second passageways 51 and 52, a potential difference is established between the multiplicity of first electrode elements 20 and the multiplicity of second electrode elements 30. The potential difference established between the first and second electrode elements 20 and 30 is a result of ion migration through the electrolyte 40 as should be well known to those skilled in the fuel cell art.

The first electrode elements 20 are connected electrically by the first electrode element connector 22 to the first endcap 60. The second electrode elements 30 are connected electrically by the second electrode element connector 32 to the intermediate casing 80, respectively. The first endcap 60 and the intermediate casing 80 are connected to the load 8 by a first and second fuel cell electrical conductor 68 and 88. The potential difference established between the first and second electrode elements 20 and 30 to produce a flow of electrical current through the load 8 balances the ion migration through the electrolyte 40.

The theory of operation of fuel cells has been available to the public for a great number of years and should be well known to those skilled in the fuel cell art. The present invention provides a novel micro fuel cell array 5 and a novel method of making the same that operates in a manner similar to a conventional fuel cell. Accordingly, the total discussion of the theory of operation of a fuel cell will not be presented since such information is widely available in the art.

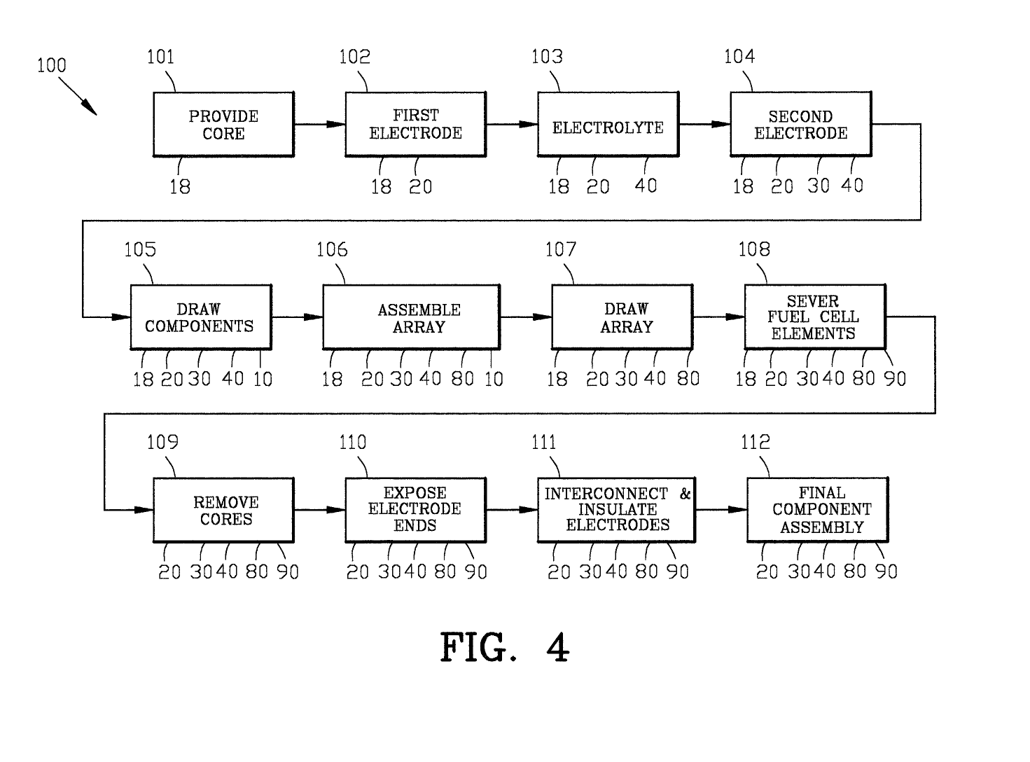

The first process of making the micro fuel cell array 5 is shown in FIGS. 4-20. This process 100 incorporates the use of a material for the second electrode element 30 that is highly gas permeable for the second gas 7. Therefore, the plurality of fuel cell elements 15 need not be spaced from one another for allowing the second gas 7 to pass between the second electrodes 30 of each of the plurality of fuel cell elements 15. The second gas 7 readily diffuses through the second electrode 30. In one example, the second electrode 30 is made of a material such as palladium whereas the second gas is hydrogen. Since hydrogen readily diffuses through palladium, each of the fuel cells elements 15 may be in contact with adjacent fuel cell elements.

FIG. 4 is a block diagram illustrating a process 100 for making the micro fuel cell array 5 of the present invention. The process 100 includes the process step 101 of providing a sacrificial material 18. Preferably, the sacrificial material 18 is in the form of a wire, usually metallic, having a substantially circular cross-section defined by outer dimension 18D.

FIG. 4 illustrates the process step 102 of covering the sacrificial material 18 with the first electrode element 20. The process of covering the sacrificial material 18 with the first electrode element 20 may be accomplished in various ways depending upon the desired physical and electrical characteristics of the micro fuel cell array 5.

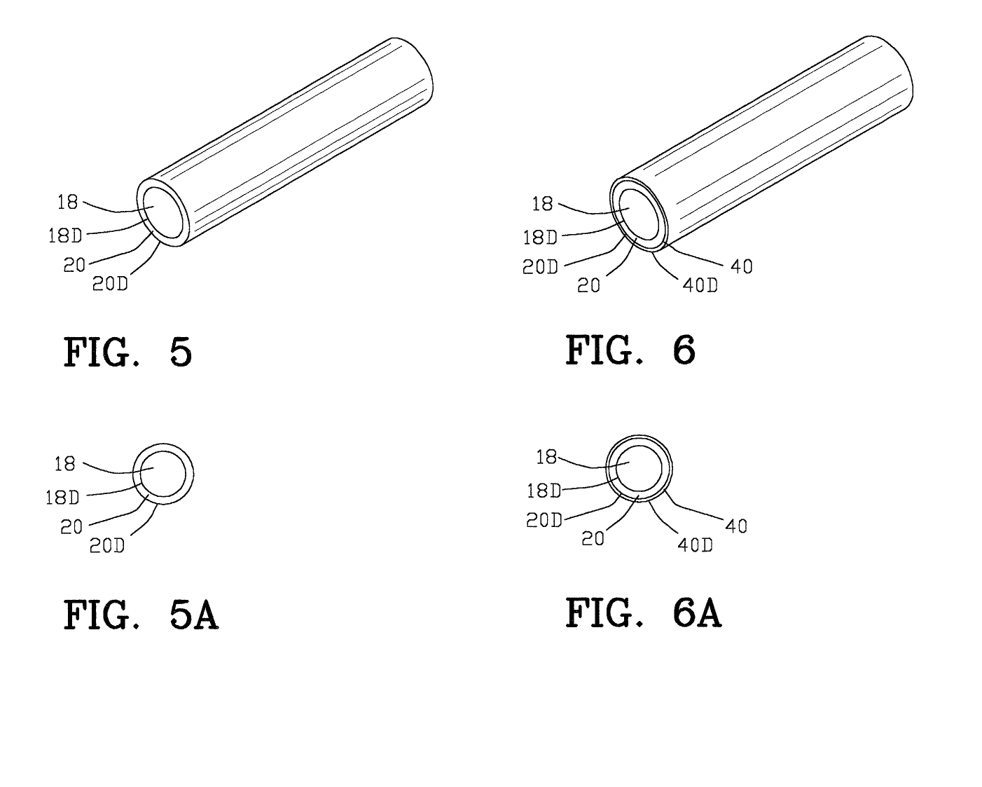

FIG. 5 is an isometric view of a first electrode element 20 covering the sacrificial material 18 with FIG. 5A being an end view of FIG. 5. The first electrode element 20 encircles the sacrificial material 18 to have a substantially circular cross-section defined by outer diameter 20D. In one example of the invention, the process step 102 of covering the sacrificial material 18 with the first electrode element 20 includes inserting the sacrificial material 18 within a preformed tube made from the first electrode element 20 material. In the alternative, the process step 102 of covering the sacrificial material 18 with the first electrode element 20 may include bending a longitudinally extending sheet of first electrode element 20 material about the sacrificial material 18 material. In another example of the invention, the process step 102 of covering the sacrificial material 18 with the first electrode element 20 includes coating the sacrificial material 18 with first electrode element 30 material. In a further alternative, the process step 102 may comprise the first electrode element 20 being electroplated on the sacrificial material 18. Preferably, the first electrode element 20 comprises a material of high ductility and is chemically different from the sacrificial material 18 material. Commonly used electrode materials include, but are not limited to platinum, silver, palladium and the like.

FIG. 4 illustrates the process step 103 of covering the first electrode element 20 with an electrolyte material 40. The process step 103 of covering the first electrode element 20 with the electrolyte material 40 may be accomplished in various ways depending upon the desired physical and electrical characteristics of the micro fuel cell array 5. Likewise, the electrolyte material 40 includes a wide variety of ion conductors depending on the desired electrochemical characteristics desired. Ceramics, glass, silicone-oxides and various polymeric materials may be successfully utilized as electrolyte materials 40.

FIG. 6 is an isometric view of an electrolyte material 40 covering the first electrode element 20 thereon with FIG. 6A being an end view of FIG. 6. The electrolyte material 40 encircles the first electrode element 20 and the sacrificial material 18 to have a substantially circular cross-section defined by outer diameter 40D.

In one example of the invention, the process step 103 of covering the first electrode element 20 includes inserting the sacrificial material 18 and the first electrode element 20 within a preformed tube made from the electrolyte material 40. In the alternative, the process step 103 of covering the first electrode element 20 may include bending a longitudinally extending sheet of electrolyte material 40 about the first electrode element 20. In another example of the invention, the process step 103 of covering the first electrode element 20 includes coating the first electrode element 20 with the electrolyte material 40.

In an alternative, the process step 103 of covering the first electrode element 20 may include the application of a precursor electrolyte material 40 that is applied to cover the first electrode element 20. In a subsequent process step, the precursor electrolyte material 40 is subjected to a reaction whereby the precursor electrolyte material 40 is converted to an electrolyte material 40. Preferably, the electrolyte material 40 comprises a material of high ductility.

FIG. 4 illustrates the process step 104 of encasing the electrolyte material 40 with the second electrode element 30. The process step 104 of covering the electrolyte material 40 with the second electrode element 30 may be accomplished in various ways depending upon the desired physical and electrical characteristics of the micro fuel cell array 5.

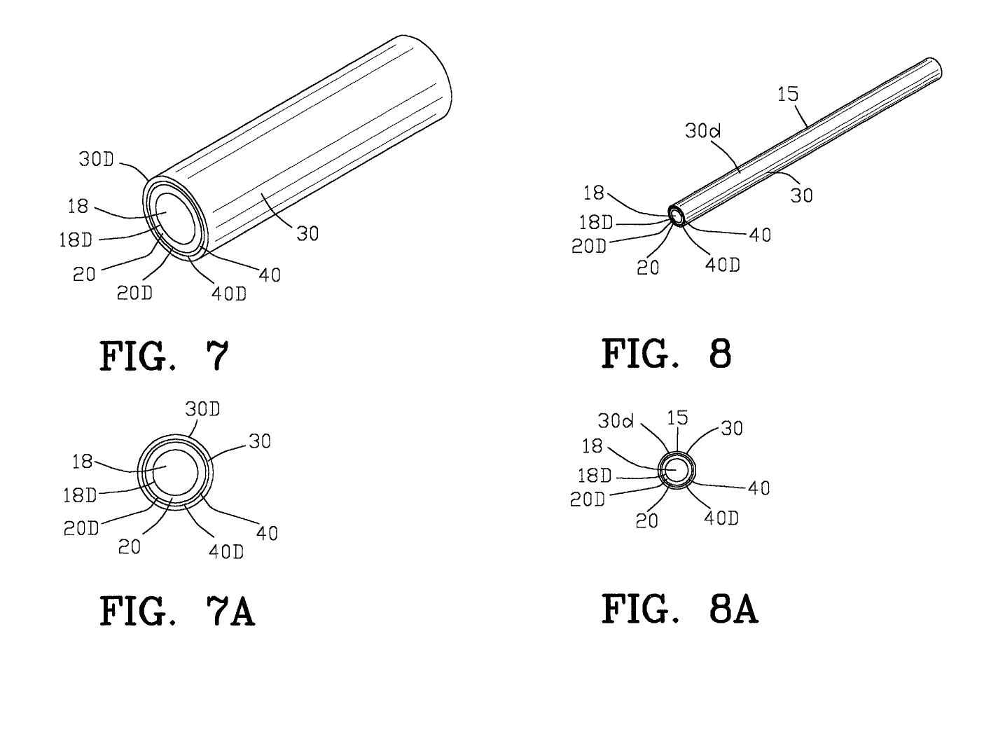

FIG. 7 is an isometric view of a second electrode element 30 encasing the electrolyte material 40, with FIG. 7A being an end view of FIG. 7. The second electrode element 30 encircles the electrolyte material 40 to have a substantially circular cross-section defined by outer diameter 30D.

In one example of the invention, the process step 104 includes inserting the coaxially assembled sacrificial material 18 and the first electrode element 20 and the electrolyte material 40 within a preformed tube made from the second electrode element 30 material. In the alternative, the process step 104 of covering the electrolyte material 40 with the second electrode element 30 material may include bending a longitudinally extending sheet of second electrode element 30 material about the electrolyte material 40.

In another example of the invention, the process step 104 includes coating the electrolyte material 40 with second electrode element 30 material. In an alternative, the process step 104 includes electroplating the second electrode element 30 onto the electrolyte material 40. Preferably, the second electrode element 30 comprises a material of high ductility and chemically different from the first electrode element 20 material.

FIG. 4 illustrates the process step 105 of drawing a second electrode element 30 encasing the sacrificial material 18, the first electrode element 20 and the electrolyte material 40 thereby forming the fuel cell element 15. Preferably, the process step 105 of drawing of the second electrode element 30 encasing the sacrificial material 18, the first electrode element 20 and the electrolyte material 40 includes the successive drawing and annealing for forming the fuel cell element 15.

FIG. 8 is an isometric view of the drawn second electrode element 30 encasing a sacrificial material 18, the first electrode element 20 and the electrolyte material 40 for forming the fuel cell element 15, with FIG. 8A being an end view of FIG. 8. Preferably, the process step 105 includes the successive drawing and annealing for reducing the outer diameter 30D to provide a reduced outer diameter 30d. The process step 105 of drawing moves the first electrode element 20 and the second electrode element 30 into engagement with opposed sides of the electrolyte material 40 forming the coaxial fuel cell element 15 thereby.

FIG. 4 illustrates the first part of process step 106 of assembling the substantially cylindrical array 10 of a multiplicity of fuel cell elements 15. The multiplicity of fuel cell elements 15 are assembled in a substantially parallel configuration for forming the substantially cylindrical array 10.

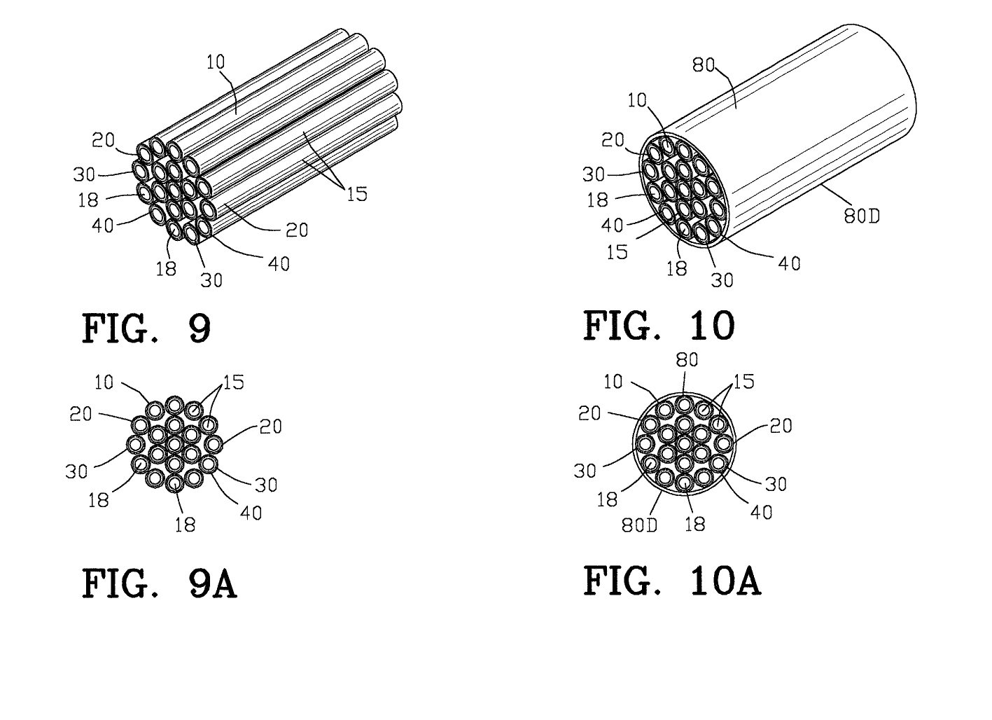

FIG. 9 is an isometric view of the multiplicity of fuel cell elements 15 assembled in a substantially parallel configuration with FIG. 9A being an end view thereof. Preferably, seven to several thousand fuel cell elements 15 are arranged to form the substantially cylindrical array 10. Although the cylindrical array 10 has been shown to be substantially cylindrical it should be understood that the assembly of the multiplicity of fuel cell elements 15 may be arranged in other than a substantially cylindrical array 10.

FIG. 4 illustrates the second part of process step 106 of encasing the multiplicity of fuel cell elements 15 within the intermediate casing 80. Preferably, the casing 80 is in the form of a continuous, electrically conductive tube, such as a metallic tube having the same or similar chemical properties as the second electrode elements 30.

FIG. 10 is an isometric view of a multiplicity of fuel cell elements 15 assembled within the intermediate casing 80 with FIG. 10A being an end view of FIG. 10. In one example of the invention, the second part of process step 106 includes inserting the multiplicity of fuel cell elements 15 within a preformed tube made from the casing material 80. In the alternative, the second part of process step 106 includes bending a longitudinally extending sheet of casing material 80 about the multiplicity of fuel cell elements 15.

FIG. 4 illustrates the process step 107 of drawing the intermediate casing 80 with the multiplicity of fuel cell elements 15 contained therein. The process step 107 of drawing the intermediate casing 80 with the multiplicity of fuel cell elements 15 contained therein may include the successive drawing and annealing, forming a drawn fuel cell member 13.

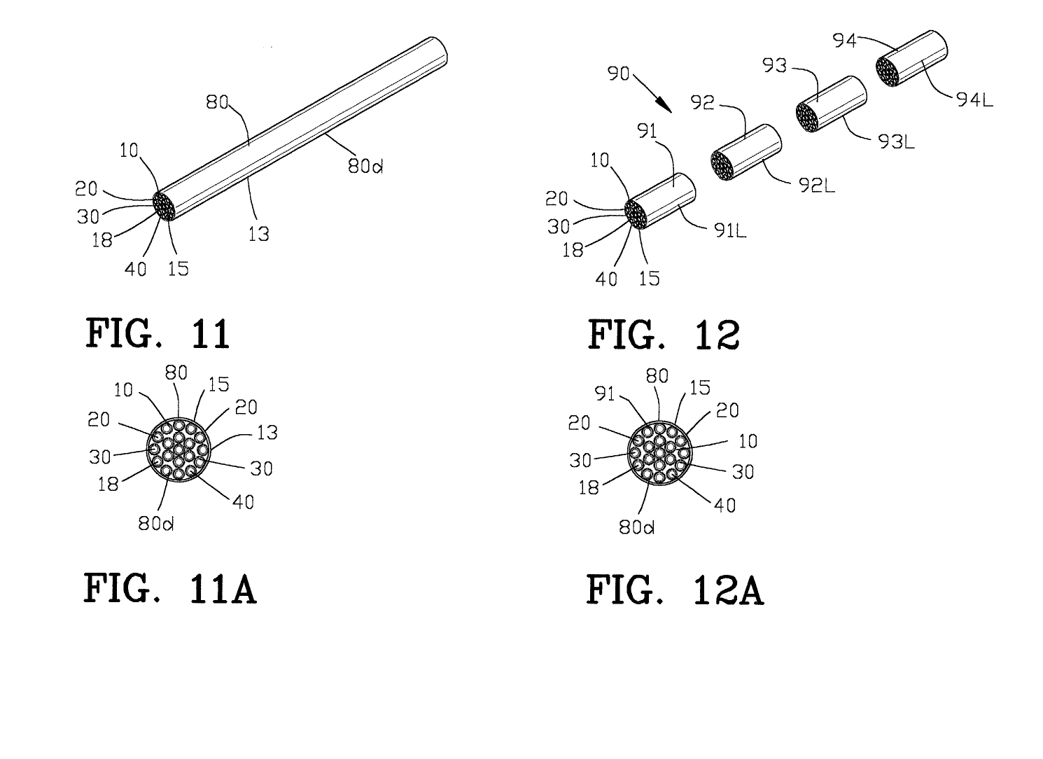

FIG. 11 is an isometric view of the intermediate casing 80 after the process step 107 of drawing the intermediate casing 80 with FIG. 11A being an enlarged end view of FIG. 11. The process step 107 of drawing the intermediate casing 80 and the multiplicity of fuel cell elements 15 therein provides three distinct effects. Firstly, the process step 107 reduces the outer diameter 80D of the intermediate casing 80. Secondly, the process step 107 reduces the corresponding outer diameter 15D of each of the fuel cell elements 15. Thirdly, the drawing process step 107 electrically interconnects each of the second electrode elements 30 of the multiplicity of fuel cell elements 15.

FIG. 4 illustrates the process step 108 of severing the drawn fuel cell member 13. The drawn fuel cell member 13 comprising the casing 80 with the multiplicity of fuel cell elements 15 therein is severed into segments 90 for enabling the removal of the sacrificial material 18.

FIG. 12 is an isometric view after severing the drawn fuel cell member 13 of FIG. 11 with FIG. 12A being an enlarged end view of FIG. 12. The drawn fuel cell member 13 comprising the casing 80 with the multiplicity of fuel cell elements 15 therein is severed into segments 91-94 having a length 91L-94L for enabling the removal of the sacrificial material 18. More specifically, the drawn fuel cell member 13 is severed into segments 91-94 having a length 91L-94L sufficiently small for enabling the complete removal of the sacrificial material 18 for providing the first gas passageway 51, while being sufficiently long to obtain the desired performance of the fully assembled micro fuel cell array 5.

FIG. 4 illustrates the process step 109 of removing the sacrificial material 18 from the severed fuel cell segments 91-94. A preferable method of removal of sacrificial material 18 comprises chemical removal, by chemical reaction or chemical etching. Preferably, the chemical chosen for the dissolution and removal of the sacrificial material 18 is substantially chemically inert to and exhibits no substantial deleterious effects on the first and the second electrodes 20 and 30 and the electrolyte material 40 or the intermediate casing 80. It should be understood by those skilled in the art that other methods of removal of sacrificial material may be utilized within the scope of the present invention. These alternative methods include mechanical, thermal and the like.

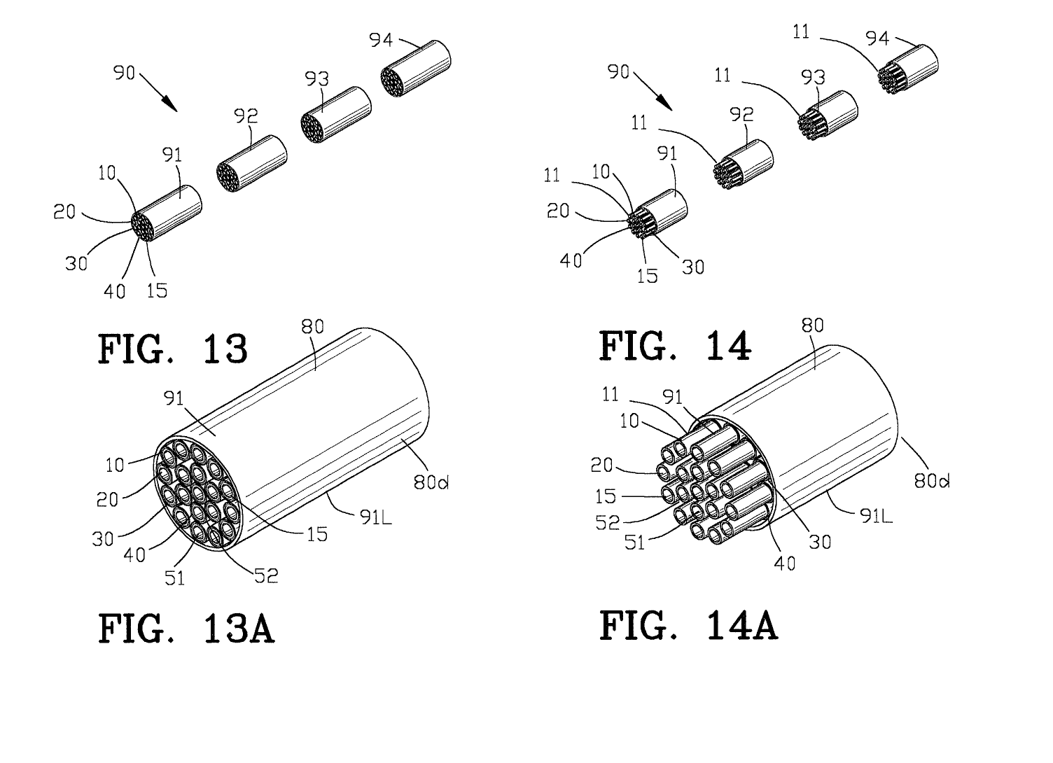

FIG. 13 is an isometric view of a plurality of fuel cell segments 91-94 of FIG. 12 after the chemical removal of the sacrificial material 18 from the fuel cell segments 91-94 with FIG. 13A being an enlarged isometric view of a single fuel cell segment 91 of FIG. 13. The chemical removal of the sacrificial material 18 provides the first gas passageway 51 through each of the multiplicity of fuel cell elements 15.

FIG. 4 illustrates the first part of process step 110 of exposing a first end portion 11 of each first electrode element 20 of the multiplicity of fuel cell elements 15. The first end portion 11 of each first electrode element 20 is exposed upon the removal of the intermediate casing 80 and the second electrode element 30 and the electrolyte material 40.

FIG. 14 is an isometric view of a plurality of fuel cells segments 91-94 of FIG. 13 with FIG. 14A being an enlarged isometric view of a single fuel cell segment 91 of FIG. 14. The first end portion 11 of each first electrode element 20 is exposed by removing the intermediate casing 80 and the second electrode element 30 and the electrolyte material 40.

In one process of the present invention, the process step 110 includes chemically removing the electrolyte material 40 and the second electrode element 30 and the intermediate casing 80. Preferably the electrolyte material 40 and the second electrode element 30 and the intermediate casing 80 are partially immersed in a solution, such as an acid, for dissolving the immersed portion of the electrolyte material 40 and the second electrode element 30 and the intermediate casing 80.

FIG. 4 illustrates the second part of process step 110 of exposing a second end 12 portion of each first electrode element 20 of the multiplicity of fuel cell elements 15. The second end 12 portion of each first electrode element 20 is exposed upon the removal of the intermediate casing 80 and the second electrode element 30 and the electrolyte material 40.

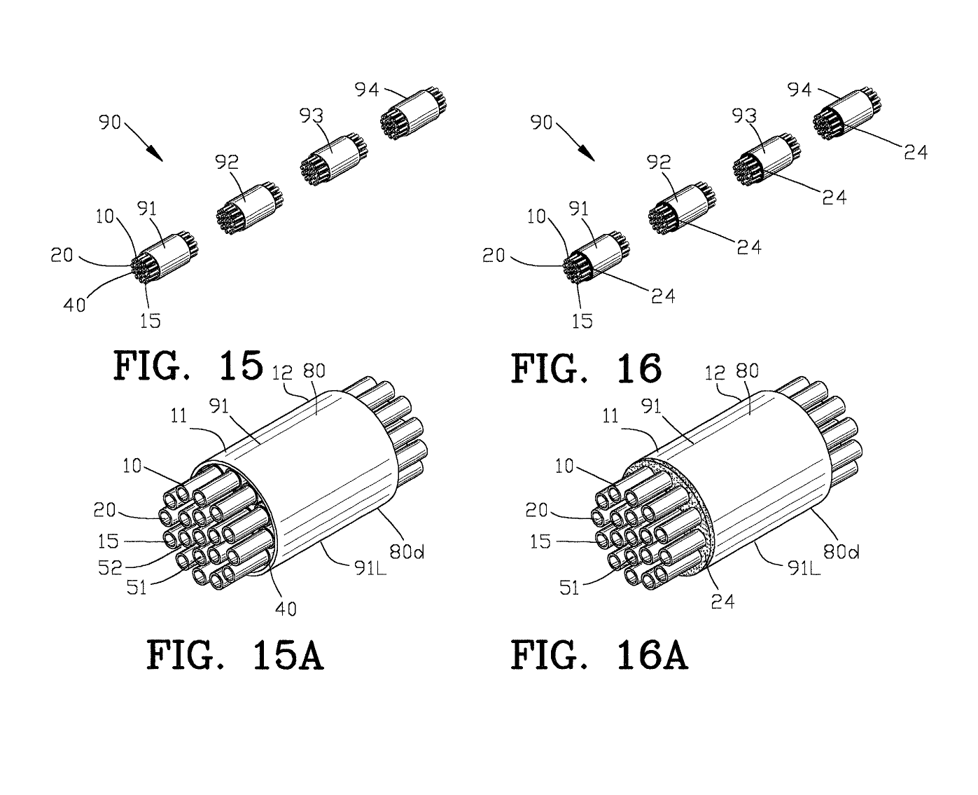

FIG. 15 is an isometric view of a plurality of fuel cells segments 91-94 of FIG. 14 with FIG. 15A being an enlarged isometric view of a single fuel cell 91 of FIG. 15. The second end 12 portion of each first electrode element 20 is exposed by removing the intermediate casing 80 and the second electrode element 30 and the electrolyte material 40.

In one process of the present invention, the second part of process step 110 may include chemically removing the electrolyte material 40 and the second electrode element 30 and the intermediate casing 80. Preferably the electrolyte material 40 and the second electrode element 30 and the intermediate casing 80 are partially immersed in a solution, such as an acid, for dissolving the immersed portion of the electrolyte material 40 and the second electrode element 30 and the intermediate casing 80. In an alternative process, intermediate casing 80 may be mechanically removed, while the electrolyte material 40 and the second electrode element 30 may be chemically removed.

FIG. 4 illustrates the first part of process step 111 of installing an insulator 24 on a first end 11 portion of each first electrode element 20 of the fuel cell segment 90.

FIG. 16 is an isometric view of a plurality of fuel cells segments 91-94 of FIG. 15 with FIG. 16A being an enlarged isometric view of a single fuel cell 91 of FIG. 16. The first electrode insulator 24 is illustrated installed on the first end 11 portion of the first electrode elements 20. The first electrode insulator 24 provides electrical insulation between first electrode elements 20 and intermediate casing 80. The insulator 24 also establishes a barrier for providing a gas tight seal between the first gas 6 entering the first gas passageways 51 and the second gas 7 entering the second gas passageways 52.

FIG. 4 illustrates the second part of process step 111 of installing a second electrode element connector 32 on a second end 12 portion of each second electrode element 30 of fuel cell segment 90.

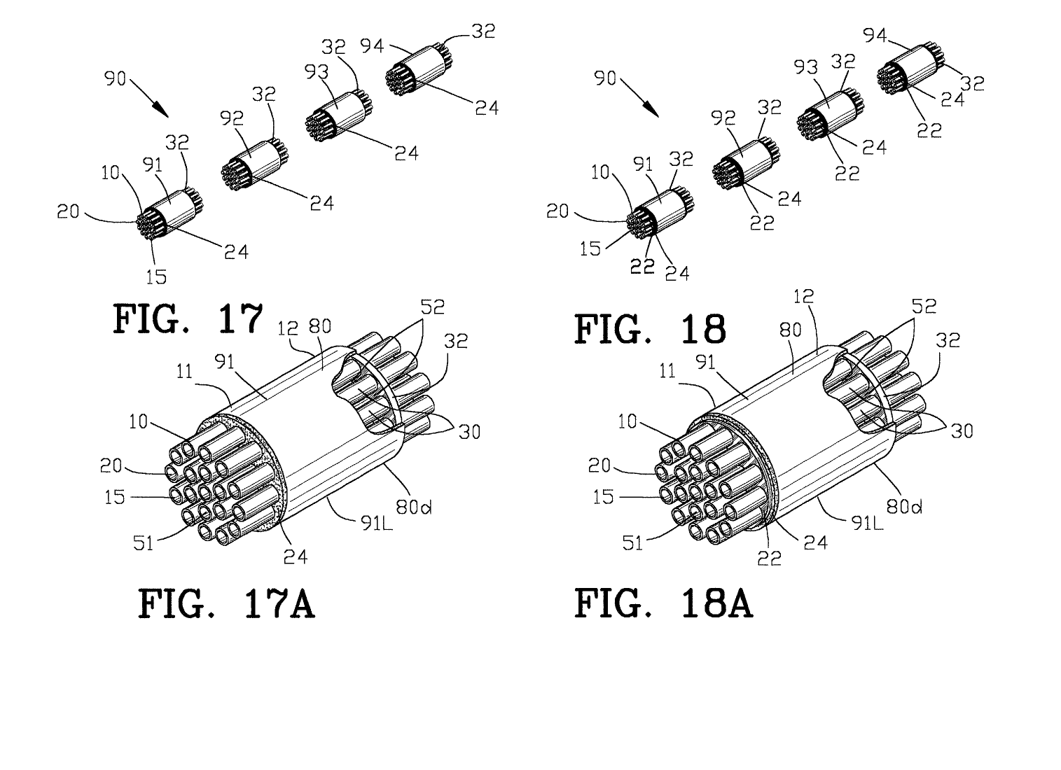

FIG. 17 is an isometric view of a plurality of fuel cells segments 91-94 of FIG. 16 with FIG. 17A being an enlarged partially cut-away isometric view of a single fuel cell 91 of FIG. 17. FIGS. 17 and 17A illustrate the second electrode element connector 32 installed in the intermediate casing 80. The second electrode element connector 32 electrically interconnects the plurality of second electrode elements 30 and the intermediate casing 80.

FIG. 4 illustrates the third part of process step 111 of installing a first electrode element connector 22 on a first end 11 portion of each first electrode element 20 of the multiplicity of fuel cell elements 15.

FIG. 18 is an isometric view of a plurality of fuel cells segments 91-94 of FIG. 17 with FIG. 18A being an enlarged partially cut-away isometric view of a single fuel cell 91 of FIG. 18. FIGS. 18 and 18A illustrate the first electrode element connector 22 installed on the first end 11 portion of the first electrode elements 20. The first electrode element connector 22 electrically interconnects the first electrode elements 20 with the first endcap 60 (not shown). Electrical isolation of the first electrode elements 20 and the first electrode element connector 22 from the intermediate casing 80 is maintained by the first insulator 24.

FIG. 4 illustrates the fourth part of process step 111 of installing an insulator 34 on a second end 12 portion of each first electrode element 20 of the fuel cell segment 90.

FIG. 19 is an isometric view of a plurality of fuel cells segments 91-94 of FIG. 18 with FIG. 19A being an enlarged partially cut-away isometric view of a single fuel cell segment 91 of FIG. 19. FIGS. 19 and 19A illustrate the second electrode insulator 34 installed on the second end 12 portion of the first electrode elements 20. The second electrode insulator 34 provides electrical insulation between first electrode elements 20 and the second electrode elements 30 and the intermediate casing 80. The insulator 34 also establishes a barrier for providing a gas tight seal between the first gas 6 exiting the first gas passageways 51 and the second gas 7 present in the second gas passageways 52.

FIG. 4 illustrates the process step 112 of completing the assembly of the micro fuel cell array 5 and the electrical connection to a load 8. Following completion of the micro fuel cell array 5, a first gas 6, including a first gas 6 source and flow controls are affixed to the first gas inlet port 64 and a second gas 7, including a second gas 7 source and flow controls are affixed to the second gas inlet port 84.

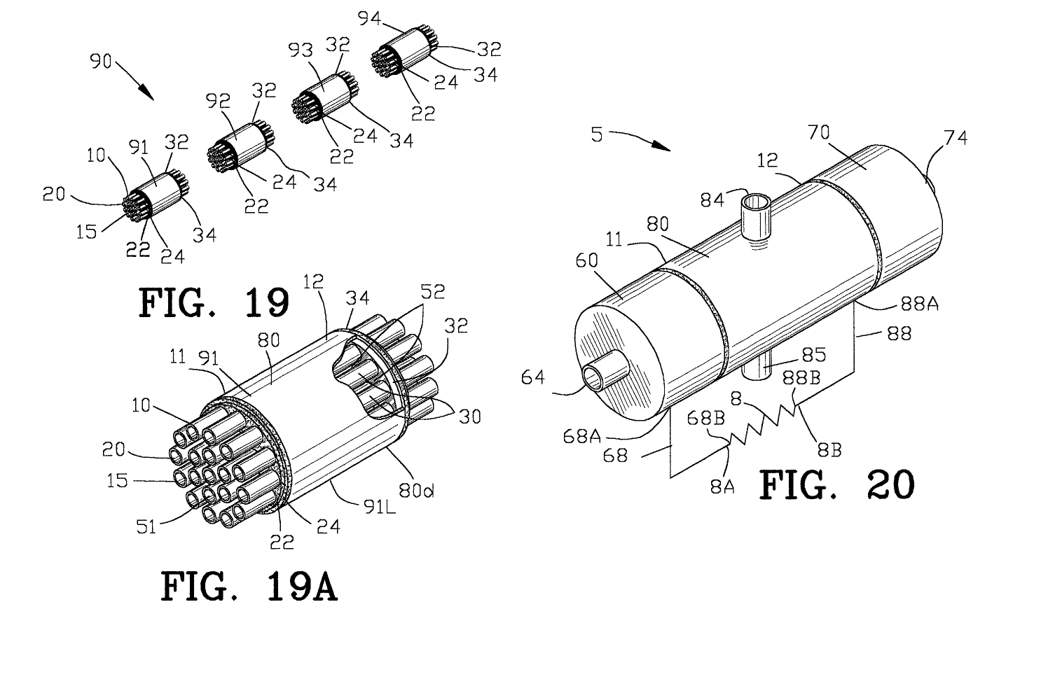

FIG. 20 is an isometric view illustrating the installation of a first and a second endcap 60 and 70, a first and a second gas inlet port 64 and 84 and a first and a second gas outlet port 74 and 85 on a micro fuel cell array 5. Endcap 60 is mechanically affixed to a first end 11 of casing 80 enabling first gas inlet port 64 to be in fluid communication with the internal volume of endcap 60. Endcap 70 is mechanically affixed to a second end 12 of casing 80 enabling first gas outlet port 74 to be in fluid communication with the internal volume of endcap 70. A first orifice is bored through casing 80 and second gas inlet port 84 is affixed thereto providing fluid communication between second gas inlet port and the internal volume of casing 80. A second orifice is bored through casing 80 and second-gas outlet port 85 is affixed thereto providing fluid communication between second gas inlet port and the internal volume of casing 80. A first electrical conductor 68 is affixed at a first end 68A to endcap 60 and affixed at a second end 68B to a first end 8A of electrical load 8. A second electrical conductor 88 is affixed at a first end 88A to intermediate casing 80 and affixed at a second end 88B to a second end 8B of load 8.

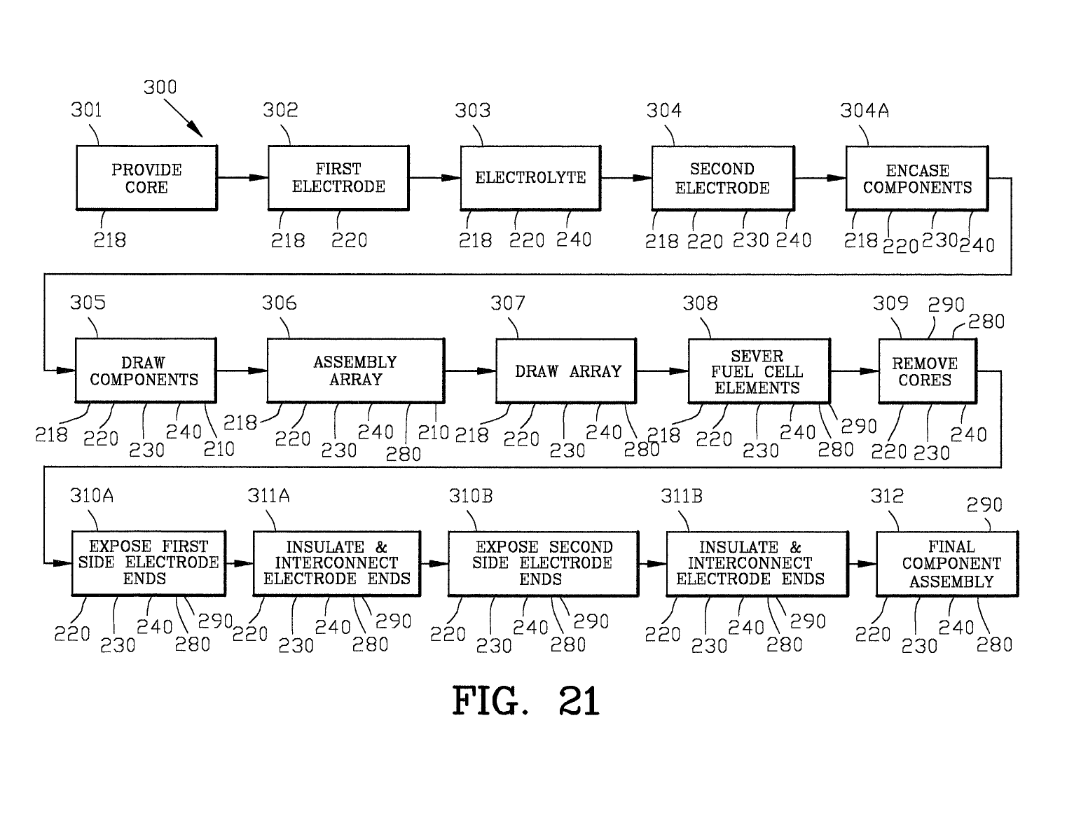

The second process of making the micro fuel cell array 205 is shown in FIGS. 21-38. This process uses the same identification numbers used in description of the previous first process increased by a factor of two hundred. This process 300 incorporates the use of a second sacrificial material 219 placed about each of the second electrodes 230 of each of the fuel cell elements 215. After the sacrificial material 219 is removed, a space exists between adjacent fuel cell elements 215 allowing the second gas 207 to readily pass between the adjacent fuel cell elements 215.

FIG. 21 is a block diagram illustrating a second process 300 of forming the micro fuel cell array 210 of the present invention. The process step of 301 to provide a core of sacrificial material 218, the process step 302 to cover the core of sacrificial material 218 with a first electrode material 220, the process step 303 to cover the first electrode 220 with an electrolyte material 240, and the process step 304 to encase the electrolyte 240 with a second electrode material 230 comprises the same process steps previously described in the first embodiment of the present invention as illustrated in FIG. 4 process steps 101-104.

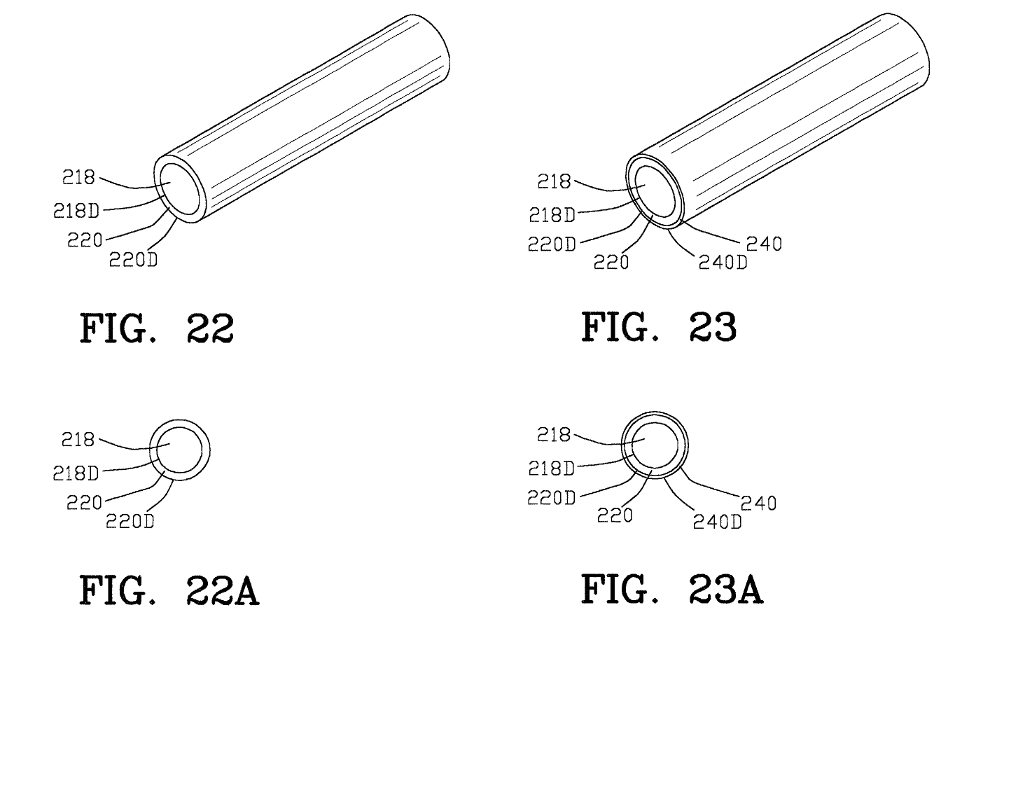

FIG. 22 illustrates process step 302 of FIG. 21, and is an isometric view of a first electrode element 220 encasing a sacrificial material 218. FIG. 22A is an end view of FIG. 22. Preferably, the first electrode element 220 comprises a material of high ductility and chemically different from the sacrificial material 218.

FIG. 23 illustrates process step 303 of FIG. 21, and is an isometric view of an electrolyte material 240 covering the first electrode element 220 encasing a sacrificial material 218. FIG. 23A is an end view of FIG. 23. In one example of the invention the first electrode element 220 is inserted within a preformed tube made from the electrolyte material 240. In an alternative, the first electrode element 220 may be covered by bending a longitudinally extending sheet of electrolyte material 240 about the first electrode element 220. In another example of the invention, covering the first electrode element 220 includes coating the first electrode element 220 with the electrolyte material 240.

In an alternative, the process step 303 of covering the first electrode element 220 may include the application of a precursor electrolyte material 240 that is applied to cover the first electrode element 220. In a subsequent process step, the precursor electrolyte material 240 is subjected to a reaction whereby the precursor electrolyte material 240 is converted to an electrolyte material 240. Preferably, the electrolyte material 240 comprises a material of high ductility.

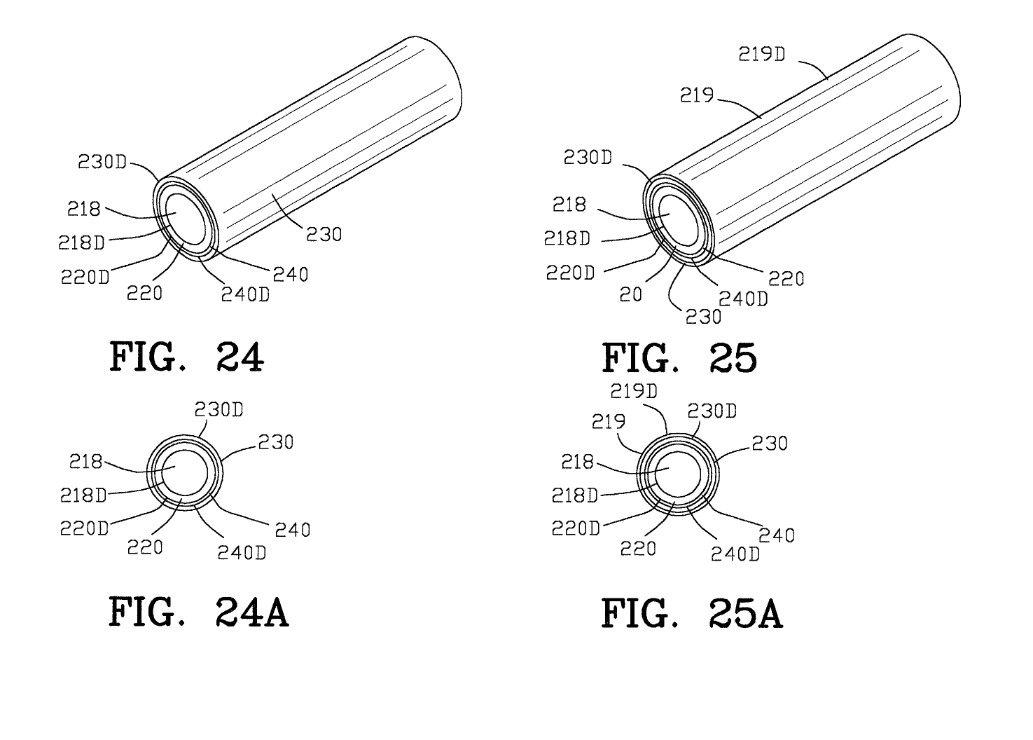

FIG. 24 illustrates process step 304 of FIG. 21, and is an isometric view of a second electrode element 230 encasing the electrolyte material 240 covering the first electrode element 220 encasing a sacrificial material 218. FIG. 24A is an end view of FIG. 24. As previously described relative to the first process, encasing the electrolyte material 240 with a second electrode element 230 may be accomplished in several ways depending on the physical and chemical characteristics desired in the micro fuel cell array 205. One example comprises the insertion of the coaxially assembled first sacrificial material 218, the first electrode 220 and electrolyte material 240 into a preformed tube made from the second electrode element material 230. Another example is to cover the electrolyte material 240 by bending a longitudinally extending sheet of second electrode element 230 material about the electrolyte material 240. In another example, the second electrode element 230 material may be coated over the electrolyte material 240. In the alternative, the second electrode element 230 material may be electroplated onto the electrolyte material 240. Preferably, the second electrode 230 element comprises a material of high ductility and chemically different from the first electrode element material.

FIG. 21 illustrates the process step 304A of a second sacrificial material 219 encasing the coaxial assembly of the first sacrificial material 218, the first electrode element 220, the electrolyte material 240, and the second electrode element 230.

FIG. 25 is an isometric view of a second sacrificial material 219 encasing the second electrode element 230. FIG. 25A is an end view of FIG. 25. The second sacrificial material 219 encircles the second electrode 230 to have a substantially circular cross-section defined by outer diameter 219D. In one example of the invention, the process step 304A of covering the second electrode element 230 with the second sacrificial material 219 includes inserting the second electrode element 230 within a preformed tube made from the sacrificial material 219.

In the alternative, the process step 304A of covering the second electrode element 230 with the sacrificial material 219 may include bending a longitudinally extending sheet of the sacrificial material 219 about the second electrode element 230. In another example of the invention, the process step 304A of covering the second electrode element 230 includes coating the second electrode element 230 with sacrificial material 219. In a further alternative, the process step 304A may comprise the sacrificial material 219 being electroplated on the second electrode element 230. Preferably, the sacrificial material 219 comprises a material of high ductility and chemically different from the second electrode element 230.

FIG. 21 illustrates the process step 305 of drawing the fuel cell element 215 and further illustrates the process step 306, assembly of a multiplicity of fuel cell elements 215 to form a substantially cylindrical array 210, the process step 307, drawing the cylindrical array 210 of a multiplicity of fuel cell elements 215, the process step 308, severing the drawn cylindrical array 210, and process step 309 removing the first sacrificial core 218. Process steps 305-309 illustrated in FIG. 21 comprise the same process steps previously described in the first embodiment of the present invention as illustrated in FIG. 4 process steps 105-109.

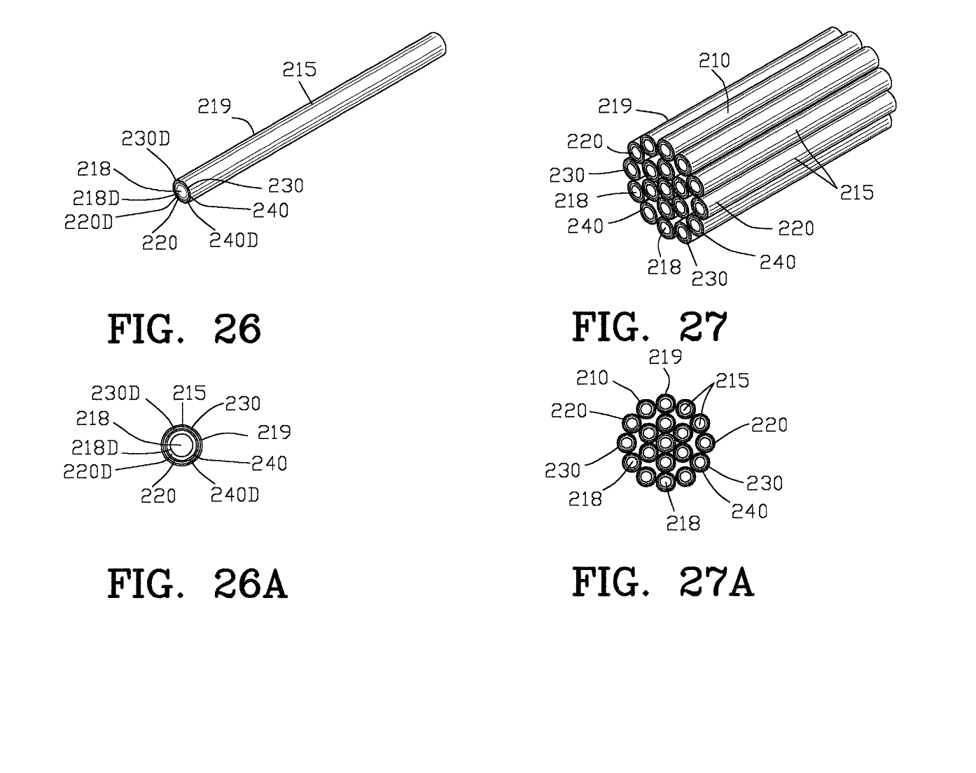

FIG. 26 illustrates process step 305 of FIG. 21, and is an isometric view of the first and second electrode elements 220, 230 and electrolyte 240 and the first and second sacrificial materials 218, 219 after drawing. FIG. 26A is an end view of FIG. 26. Preferably, the process step 305 of drawing the first and second electrode elements 220, 230 and electrolyte 240 and the first and second sacrificial materials 218, 219 includes a series of successive drawing and annealing steps.

FIG. 27 is an isometric view of an array of fuel cell elements 215 of FIG. 26. FIG. 27A is an end view of FIG. 27. Preferably seven to several thousand fuel cell elements 215 are arranged to form the substantially cylindrical array 210. It should be understood by those skilled in the art that the assembly of the cylindrical array 210 may be arranged in other than a cylindrical array configuration.

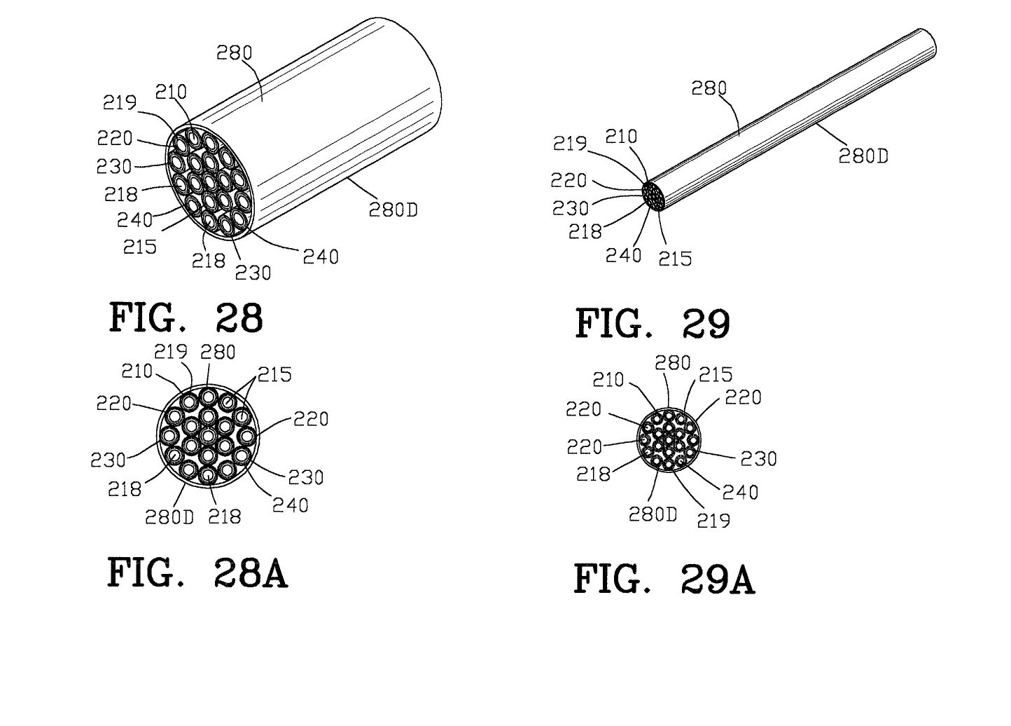

FIG. 28 illustrates process step 306 of FIG. 21, and is an isometric view of the cylindrical array 210 of fuel cell elements 215 of FIG. 27 bundled and encased in a tubular intermediate casing 280. Preferably, the intermediate casing 280 is a continuous electrically conductive tube having the same or similar properties as the second electrode elements 230.

FIG. 29 illustrates process step 307 of FIG. 21 and is an isometric view of the encased cylindrical array 210 of fuel cell elements 215 of FIG. 28 after the drawing process. FIG. 29A is an end view of FIG. 29. The process step 307 of drawing the intermediate casing 280 with the multiplicity of fuel cell elements 215 therein may include successive steps of drawing and annealing, forming a drawn fuel cell member 213.

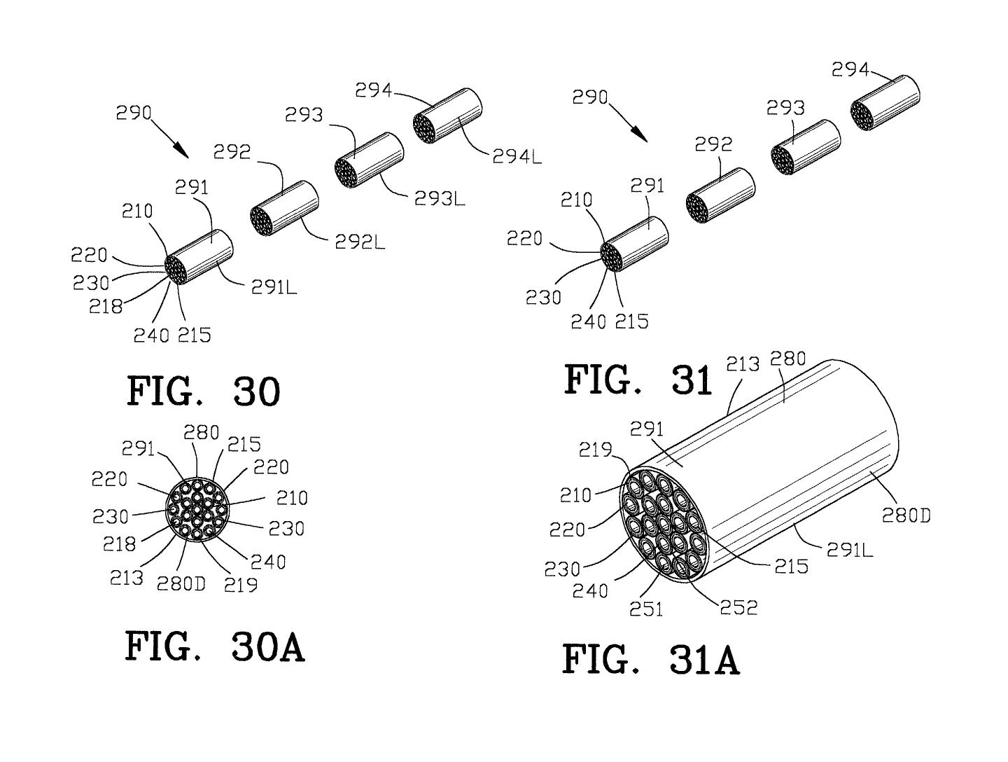

FIG. 30 illustrates process step 308 of FIG. 21 and is an isometric view of the severing of the drawn fuel cell member 213 of the multiplicity of fuel cell elements 215 to form drawn fuel cell segments 290. FIG. 30A is an end view of FIG. 30. The drawn fuel cell member 213 comprising the casing 280 with the multiplicity of fuel cell elements 215 therein is severed into segments 291-294 having a length 291L-294L for enabling the removal of the first sacrificial material 218. More specifically, the drawn fuel cell member 213 is severed into segments 291294 having a length 291L-294L. The lengths 291L-294L are sufficiently small for enabling the complete removal of the sacrificial material 218 for providing the first gas passageway 251, while being sufficiently long to obtain the desired performance of the fully assembled micro fuel cell array 205.

FIG. 31 illustrates process step 309 of FIG. 21 and is an isometric view illustrating the removal of the first sacrificial material 218 from the fuel cell segments 290 of FIG. 30. FIG. 31A is an enlarged isometric view of a single fuel cell segment 291 of FIG. 31. FIGS. 31 and 31A illustrate the process step 309 of chemically removing the first sacrificial material 218 from the severed fuel cell segments 291-294. Preferably, the chemical chosen for the dissolution and removal of the sacrificial material 218 is substantially chemically inert to and exhibits no substantial deleterious effects on the first and the second electrode elements 220 and 230, the electrolyte material 240, the intermediate casing 280, or the second sacrificial material 219.

FIG. 21 illustrates the process step 310A of exposing a first end 211 portion of each first electrode element 220 of the multiplicity of first electrode elements 220.

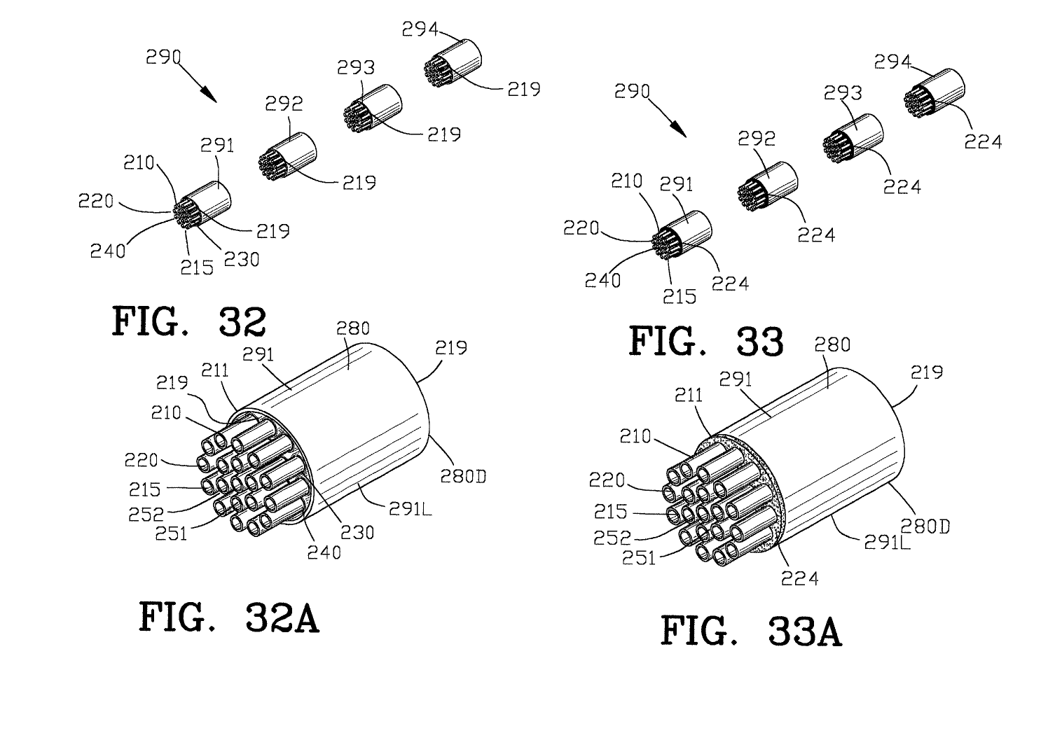

FIG. 32 is an isometric view illustrating the exposed first electrodes 220 of a plurality of fuel cell segments 290. FIG. 32A is an enlarged isometric view of a single fuel cell segment 291 of FIG. 32. The exposure of the first electrodes 220 is accomplished by removing a first end 211 portion of the intermediate casing 280, a first end 211 portion of the second sacrificial material 219, a first end 211 portion of the second electrodes 230 and a first end 211 portion of the electrolyte 240. The drawing process previously described in step 307 of FIG. 21 as illustrated in FIG. 29, causes the second sacrificial material 219 to substantially fill all the voided volume between the second electrodes 240 and the intermediate casing 280.

FIG. 21 illustrates a first part of the process step 311 A of installing an insulator 224 on a first end 211 of each first electrode element 220 of a fuel cell segment 290.

FIG. 33 is an isometric view illustrating the installation of a first electrode insulator 224 on each of the fuel cell segments 291-294. FIG. 33A is an enlarged isometric view of a single fuel cell segment 291 of FIG. 33. The first electrode insulator 224 is illustrated installed on the end 211 portion of the first electrode elements 220. The first electrode insulator 224 provides electrical insulation between the first electrode elements 220 and the intermediate casing 280 and second electrode element 230. The insulator 224 also provides a gas tight seal between the first gas 206 entering the first gas passageway 251 and the second gas 207 entering the second gas passageway 252.

FIG. 21 illustrates a second part of process step 311A of installing a first electrode element connector 222 on a first end 211 of a fuel cell segment 290.

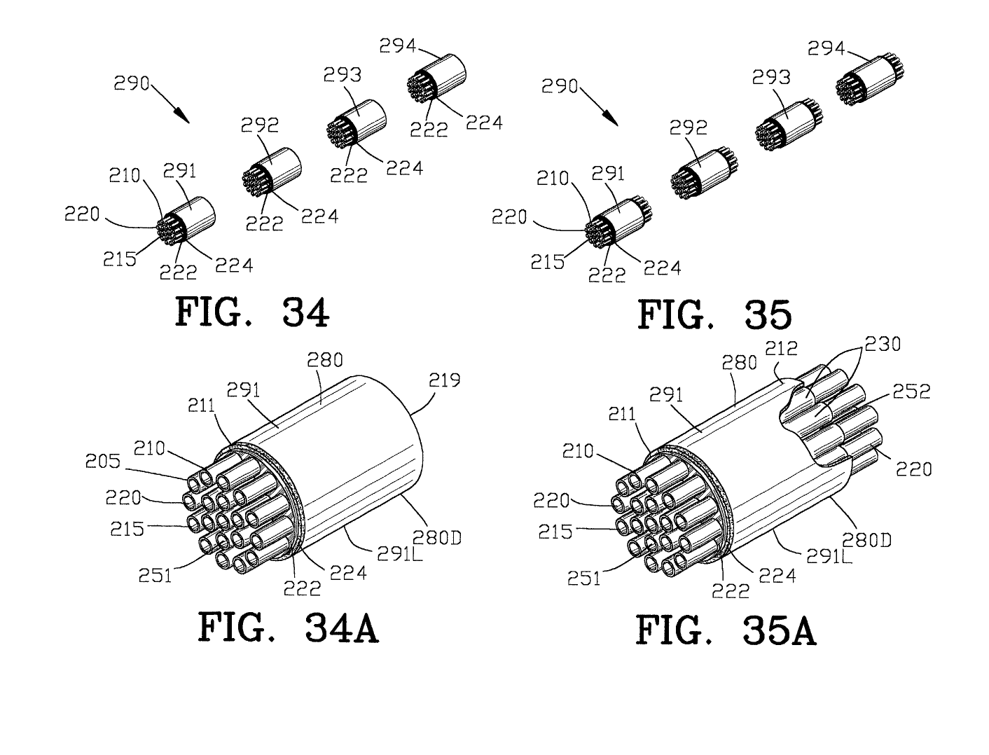

FIG. 34 is an isometric view illustrating the installation of a first electrode connector 222 on the first end 211 of each of the plurality of fuel cell segments 291-294. FIG. 34A is an enlarged isometric view of a single fuel cell segment 291 of FIG. 34. The first electrode connector 222 is illustrated installed on the first electrode elements 220 and the intermediate casing 280. The first electrode connector 222 electrically interconnects the plurality of first electrode elements 220 and the first end cap 260 (not shown). Installation of the first electrode insulator 224 and the first electrode connector 222 also provides a rigid support for the multiplicity of fuel cell elements 215 relative to the intermediate casing 280. Maintaining the rigid support of the multiplicity of fuel cell elements 215 enables chemical removal of second sacrificial material 219 to form the second gas passageway 252, while maintaining the position and orientation of the multiplicity of fuel cell elements 215 relative to the intermediate casing 280.

FIG. 21 illustrates the process step 310B of exposing a second end 212 portion of each first electrode element 220 of the multiplicity of first electrode elements 220.

FIG. 35 is an isometric view illustrating the fuel cell elements internal to intermediate casing 280 following the chemical removal of the second sacrificial material 219. FIG. 35A is an enlarged partially cut-away isometric view of a single fuel cell segment 291 of FIG. 35. The chemical removal of the second sacrificial material 219 provides interstitial voids between adjacent second electrodes 230. These interstitial voids act as second gas passageways 252 enabling flow of the second gas 207 to contact the second electrodes 230 within the intermediate casing 280.

FIG. 21 illustrates a first part of process step 311B of installing a second electrode element connector 232 on a second end 212 of a fuel cell segment 291.

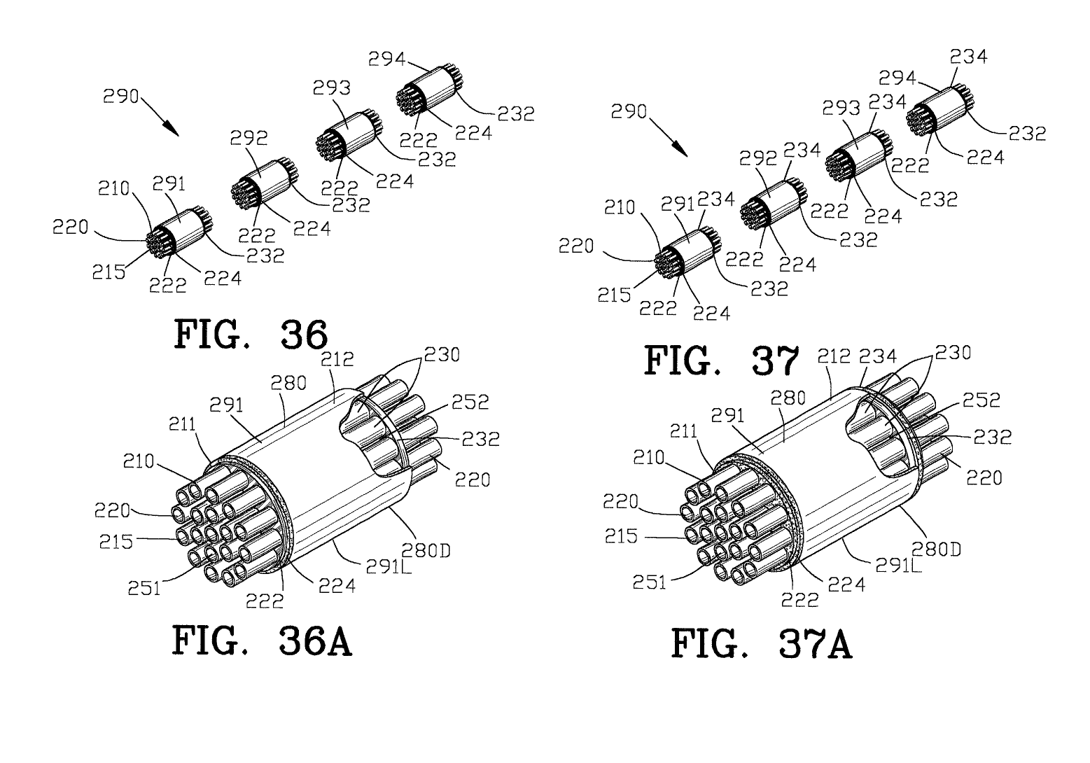

FIG. 36 is an isometric view illustrating the installation of a second electrode connector 232 on the multiplicity of second electrode elements 230. FIG. 36A is an enlarged partially cutaway isometric view of a single fuel cell segment 291 of FIG. 36. The second electrode connector 232 electrically interconnects the plurality of second electrode elements 230 and the intermediate casing 280.

FIG. 21 illustrates a second part of the process step 311B of installing an insulator on a second end 212 of a fuel cell segment 290.

FIG. 37 is an isometric view illustrating the installation of a second electrode insulator 234 on each of the fuel cell segments 291-294. FIG. 37A is an enlarged partially cut-away isometric view of a single fuel cell segment 291 of FIG. 37. The second electrode insulator 234 is illustrated installed on the second end portion 212 of the second electrode elements 230. The second electrode insulator 234 provides electrical insulation between first electrode elements 220 and intermediate casing 280 as well as providing a gas tight seal between first gas 206 and the second gas 207.

FIG. 21 illustrates the process step 312 of completing the assembly of the micro fuel cell array 205 and the electrical connection to a load 208. Following completion of the micro fuel cell array 205, a first gas 206, including a first gas 206 source and flow controls are affixed to the first gas inlet port 264 and a second gas 207, including a second gas 207 source and flow controls are affixed to the second gas inlet port 284.

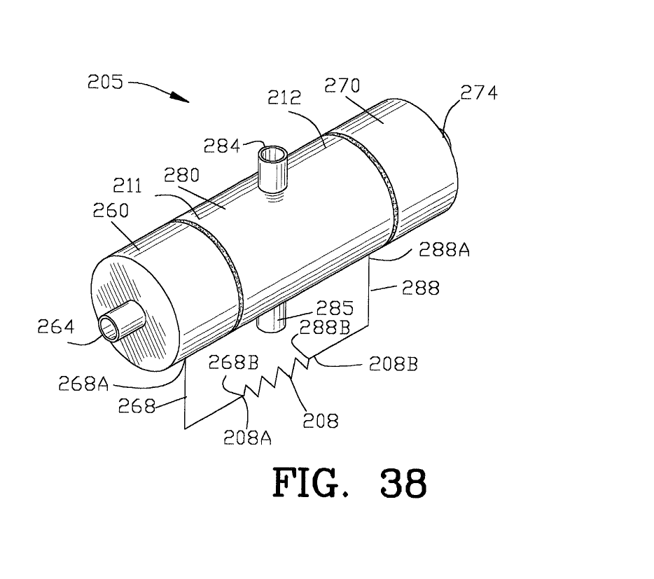

FIG. 38 is an isometric view following the installation of a first and a second end cap 260, 270 and first and second gas inlets 264, 284 and outlets 274, 285 on the single fuel cell segment 291 and illustrating a completed micro fuel cell assembly 205. First endcap 260 is mechanically affixed to a first end 211 of casing 280 enabling first gas inlet port 264 to be in fluid communication with the internal volume of the first endcap 260. Second endcap 270 is mechanically affixed to a second end 212 of the intermediate casing 280 enabling the first gas outlet port 274 to be in fluid communication with the internal volume of the second endcap 270. A first orifice is bored through casing 280 and a second gas inlet port 284 is affixed thereto providing fluid communication between the second gas inlet port 284 and the internal volume of the intermediate casing 280. A second orifice is bored through the intermediate casing 280 and a second gas outlet port 285 is affixed thereto providing fluid communication between the second gas inlet port 285 and the internal volume of the intermediate casing 280. A first electrical conductor 268 is affixed at a first end 268A to the first endcap 260 and affixed at a second end 268B to a first end 208A of electrical load 208. A second electrical conductor 288 is affixed at a first end 288A to casing 280 and affixed at a second end 288B to a second end 208B of load 208.

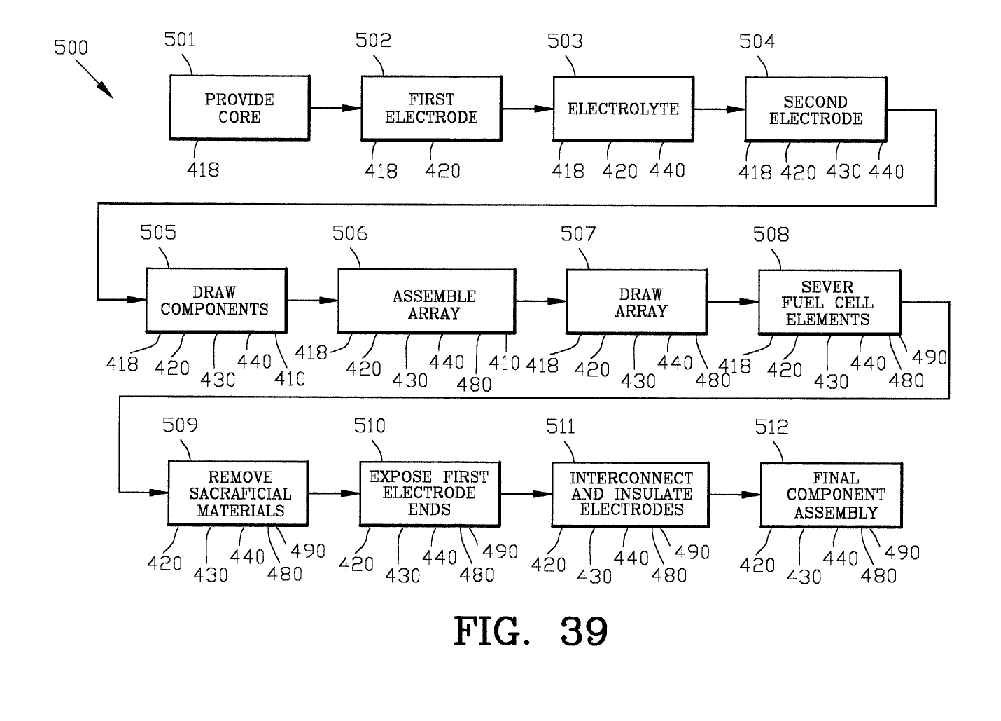

The third process 500 of making the micro fuel cell array 505 as shown in FIGS. 39-52. This process uses the same identification numbers used in description of the previous first process increased by a factor of four hundred. The process 500 incorporates the use of a plurality of the sacrificial material 418 shown as longitudinally extending sacrificial wires 418 interposed within the plurality of fuel cell elements 415 within the cylindrical array 410. The sacrificial wires 418 may be metallic wires such as copper wires or the like. After removal of the sacrificial materials 418, the longitudinally extending sacrificial wires 418 produce interstitial voids which act as second gas passageways 452 for allowing the second gas 407 to permeate through the voids for contact with the second electrodes 430 within the intermediate casing 480.

FIG. 39 is a block diagram illustrating a third process 500 of forming the micro fuel cell array 405 of the present invention. The process step of 501 to provide a core of sacrificial material 418, the process step 502 to cover the core of sacrificial material 418 with a first electrode material 420, the process step 503 to cover the first electrode 420 with an electrolyte material 440, the process step 504 to encase the electrolyte 440 with a second electrode material 430, and the process step 505 to draw the core of sacrificial material 418, first and second electrodes 420, 430 and the electrolyte 440 comprises the same process steps previously described in the first embodiment of the present invention as illustrated in FIG. 4 process steps 101-105.

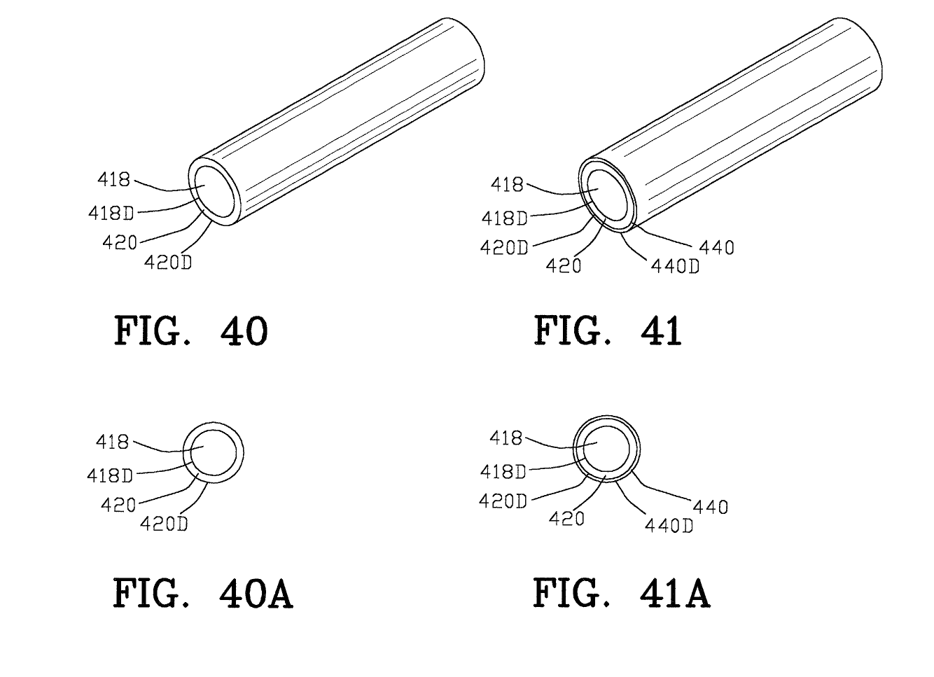

FIG. 40 illustrates process step 502 of FIG. 39, and is an isometric view of a first electrode element 420 encasing a sacrificial material 418. FIG. 40A is an end view of FIG. 40. Preferably, the first electrode element 420 comprises a material of high ductility and chemically different from the sacrificial material 418.

FIG. 41 illustrates process step 503 of FIG. 39, and is an isometric view of an electrolyte material 440 covering the first electrode element 420 encasing a sacrificial material 418. FIG. 41A is an end view of FIG. 41. In one example of the invention the first electrode element 420 is inserted within a preformed tube made from the electrolyte material 440. In an alternative, the first electrode element 420 may be overlaid by bending a longitudinally extending sheet of electrolyte material 440 about the first electrode element 420. In another example of the invention, covering the first electrode element 420 includes coating the first electrode element 420 with the electrolyte material 440.

In an alternative, the process step 503 of covering the first electrode element 420 may include the application of a precursor electrolyte material 440 that is applied to cover the first electrode element 420. In a subsequent process step, the precursor electrolyte material 440 is subjected to a reaction whereby the precursor electrolyte material 440 is converted to an electrolyte material 440. Preferably, the electrolyte material 440 comprises a material of high ductility.

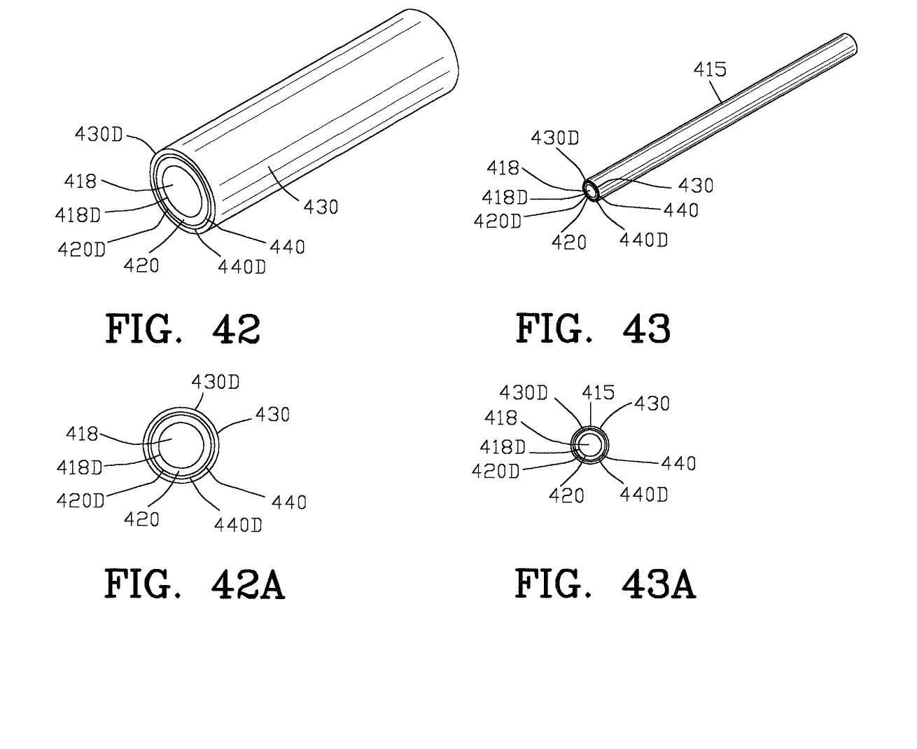

FIG. 42 illustrates process step 504 of FIG. 39, and is an isometric view of a second electrode 430 element encasing the electrolyte material 440 covering the first electrode element 420 encasing a sacrificial material 418. FIG. 42A is an end view of FIG. 42. As previously described relative to the first process, encasing the electrolyte material 440 with a second electrode element 430 may be accomplished in several ways depending on the physical and chemical characteristics desired in the micro fuel cell array 405. One example comprises the insertion of the coaxially assembled first sacrificial material 418, the first electrode 420 and electrolyte material 440 into a preformed tube made from the second electrode element 430 material. Another example is to cover the electrolyte material 440 by bending a longitudinally extending sheet of second electrode element 430 material about the electrolyte material 440. In another example, the second electrode element 430 material may be coated over the electrolyte material 440. In the alternative, the second electrode element 430 material may be electroplated onto the electrolyte material 440. Preferably, the second electrode element 430 comprises a material of high ductility and chemically different from the first electrode element material.

FIG. 43 is an isometric view after drawing the first and second electrode elements 420 and 430 and the electrolyte material 440 of FIG. 42. FIG. 43 illustrates process step 505 of FIG. 39, and is an isometric view of the first and second electrode elements 420, 430 and electrolyte 440 after drawing for forming a fuel cell element 415. FIG. 43A is an end view of FIG. 43. Preferably, the process step 505 of drawing the first and second electrode elements 420, 430 and electrolyte 440 and the first sacrificial material 418 includes a series of successive drawing and annealing steps.

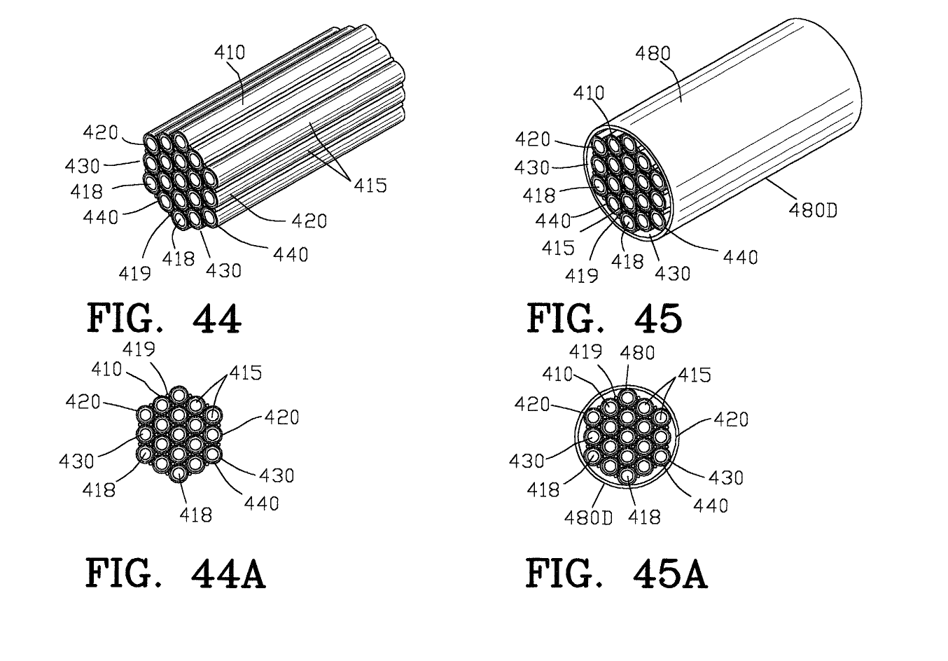

FIG. 39 illustrates the process step 506 of assembling the parallel substantially cylindrical array 410 of fuel cell elements 415 and second sacrificial materials 419. FIGS. 44 and 45 illustrates process step 506 of FIG. 39, and FIGS. 44A and 45A are end views of FIGS. 44 and 45 respectively.

FIG. 44 is an isometric view of the array of fuel cell elements 415 of FIG. 43 arranged in a parallel cylindrical array 410. A plurality of the second sacrificial materials 419 are illustrated as longitudinally extending sacrificial wires 419 interposed within the plurality of fuel cell elements 415 within the circular array 410.

FIGS. 45 is an isometric view of the array 410 of fuel cell elements 415, including the longitudinally extending sacrificial wires 419 of FIG. 44 bundled and encased in a tubular intermediate casing 480. Preferably, the casing 480 is a continuous electrically conductive tube having the same or similar properties as the second electrode elements 430.

FIG. 39 illustrates process step 507 of drawing the cylindrical array 410 of fuel cell elements 415 including the sacrificial wires 419.

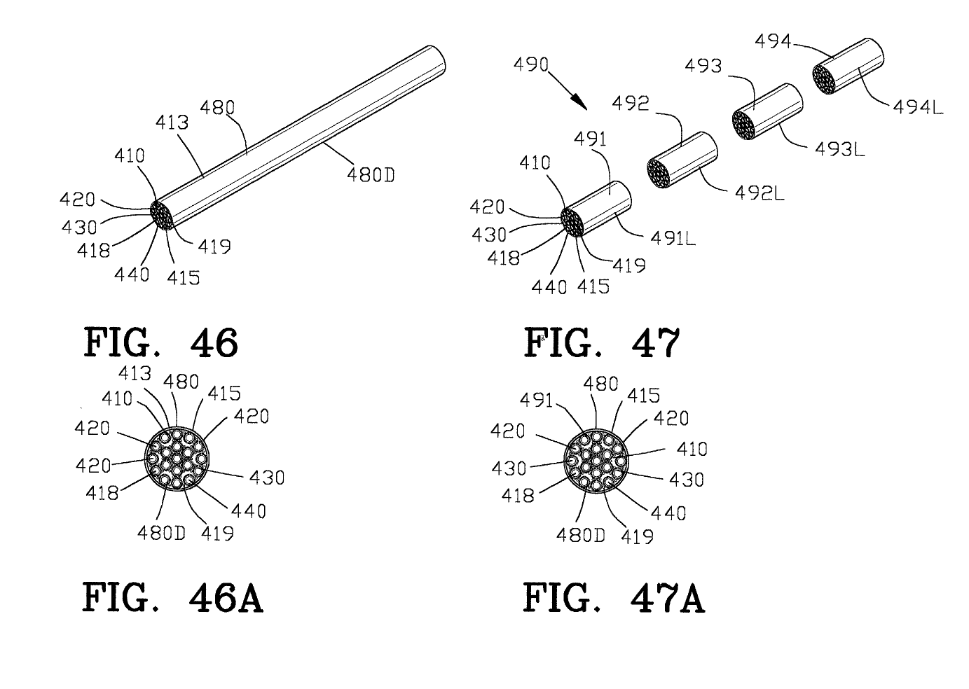

FIG. 46 is an isometric view of the encased array 410 of fuel cell elements 415 and sacrificial wires 419 of FIG. 45 after drawing. FIG. 46A is an end view of FIG. 46. The process step 507 of drawing the intermediate casing 480 with the fuel cell elements 415 and sacrificial wires 419 therein form fuel cell member 413 and may include successive steps of drawing and annealing. The drawing process step 507 has the effect of moving the first electrode element 420 and the second electrode element 430 into engagement with opposed sides of the electrolyte material 440 forming the coaxial fuel cell element 415 thereby. The drawing process further comprises a reduction in diameter of the intermediate casing 480 and subsequent compression, elongation and minimal cross-sectional deformation of the cylindrical array 410 of fuel cell elements 415 and the sacrificial wires 419. During the drawing process, the second electrode elements 430 of the fuel cell elements 415 are moved into mutual engagement.

FIG. 39 illustrates process step 508 severing of the drawn fuel cell member 413 to form drawn fuel cell segments 490.

FIG. 47 is an isometric view of the severing of the drawn fuel cell member 413 to form drawn fuel cell segments 490. FIG. 47A is an end view of FIG. 47. The drawn fuel cell member 413 comprising the casing 480 with the multiplicity of fuel cell elements 415 therein is severed into segments 491-494 having a length 491L-494L for enabling the removal of the first sacrificial material 418 and the sacrificial wires 419. More specifically, the drawn fuel cell member 413 is severed into segments 491-494 having a length 491L-494L. The lengths 491L-494L are sufficiently small for enabling the complete removal of the sacrificial material 418 and the sacrificial wires 419 for providing the first and second gas passageways 451 and 452 respectively, while being sufficiently long to obtain the desired performance of the fully assembled micro fuel cell array 405.

FIG. 39 illustrates process step 509 removing the sacrificial material 418 comprising the core and the sacrificial wires 419.

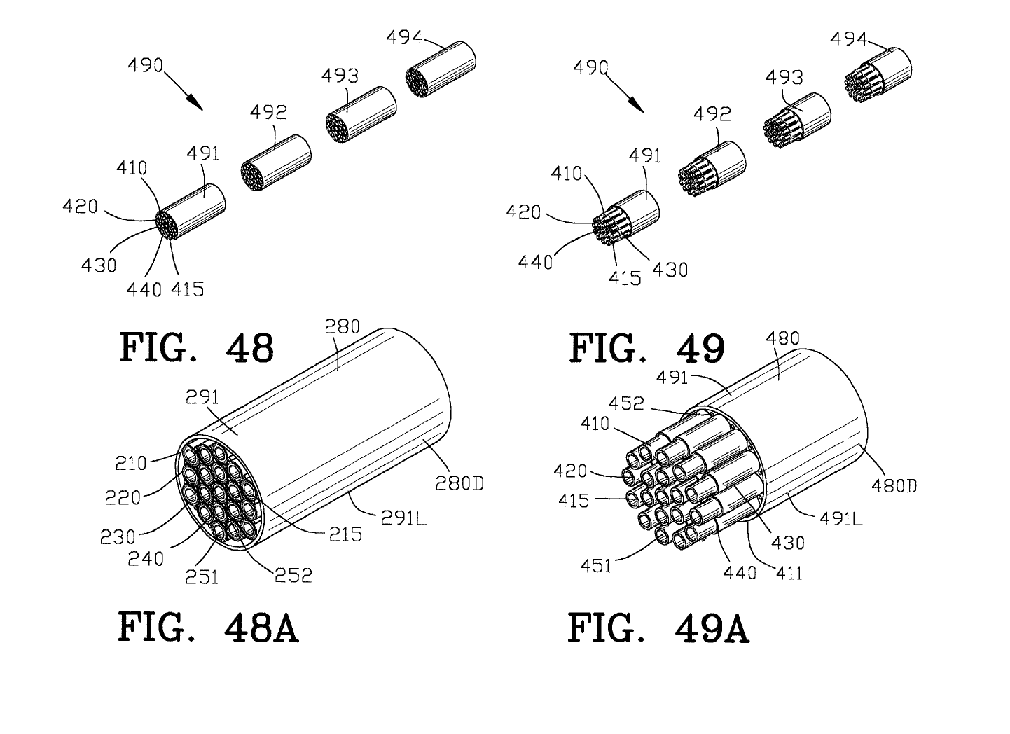

FIG. 48 is an isometric view the chemical removal of the sacrificial material 418 and the sacrificial wires 419 from the severed fuel cell segments 291-294. FIG. 48A is an end view of FIG. 48. The chemical chosen for the dissolution and removal of the sacrificial material 418 and the sacrificial wires 419 is substantially chemically inert to and exhibits no substantial deleterious effects on the first and the second electrode elements 420 and 430, the electrolyte material 440, the intermediate casing 480.

FIG. 39 illustrates process step 510 of exposing the ends of the first and second electrode element 420 and 430.

FIG. 49 is an isometric view illustrating exposed ends of the first and second electrodes 420 and 430 of a plurality of fuel cell segments 490. FIG. 49A is an enlarged isometric view of a single fuel cell segment 491 of FIG. 49. Mechanical removal of a portion of intermediate casing 480 provides exposure of a first end 411 portion of the second electrodes 430. Partial immersion of the first end 411 portion of the second electrodes 430 for chemical removal of a portion of the exposed second electrodes 430 and the electrolyte 440 provides exposure of a portion of the first electrodes 420.

FIG. 39 illustrates process step 511 of insulating the first and the second electrode elements 420 and 430 and interconnecting the first electrode 420.

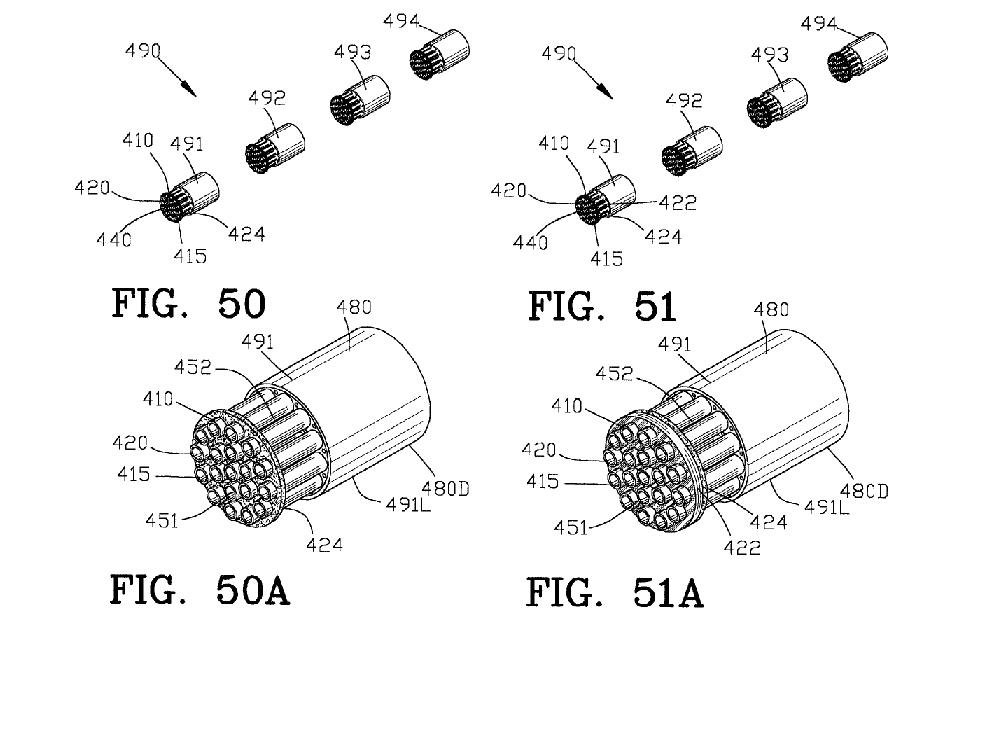

FIG. 50 is an isometric view illustrating the first part of the process step 511 of FIG. 39 the installation of an insulator 424 on each of the plurality of fuel cell segments 490. FIG. 50A is an enlarged isometric view of a single fuel cell segment 491 of FIG. 50. Insulator 424 provides electrical insulation between first electrode elements 420 and second electrode elements 430. The insulator 424 also establishes a barrier for providing a gas tight seal between the first gas 406 entering the first gas passageways 451 and the second gas 407 entering the second gas passageways 452.

FIG. 51 is an isometric view illustrating the second part of the process step 511 of FIG. 39, the installation of a first electrode connector 422 on each of the plurality of fuel cell segments 490. FIG. 51A is an enlarged isometric view of a single fuel cell segment 491 of FIG. 51. The first electrode connector 422 interconnects each of the multiplicity of first electrode elements 420 in each fuel cell segment 490 and provides an interconnection point to the load 408.

FIG. 39 illustrates process step 512 of final component assembly. Following completion of the micro fuel cell array 405, a first gas 406, including a first gas source and flow controls are affixed to the first gas inlet port 464 and a second gas 407, including a second gas source and flow controls are affixed to the second gas inlet port 484 followed by the electrical connection of the micro fuel cell array 405 to a load 408.

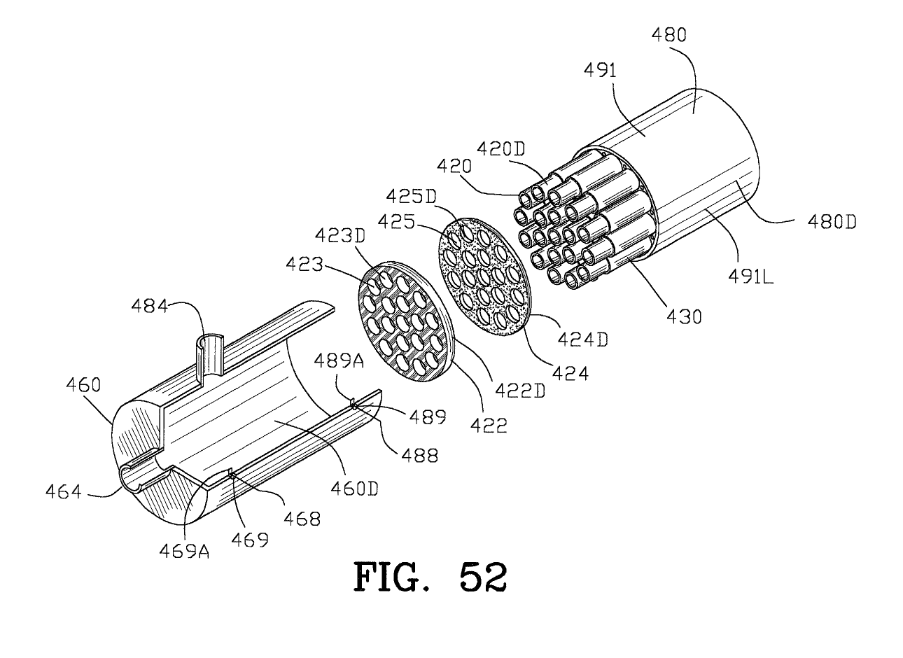

FIG. 52 is an exploded isometric view illustrating the component installation order of a micro fuel cell array 405. The intermediate casing 480 is illustrated with the first and second electrode elements 420 and 430 extending therefrom. Insulator 424 is illustrated having a diameter 424D being substantially equal to the diameter 480D of the intermediate casing 480. Insulator 424 comprises a plurality of apertures 425 having the same hole pattern as the first electrode elements 420. The diameter 425D of apertures 425 is substantially equal to the first electrode outer diameter 420D. The first electrode connector 422 is illustrated having a diameter 422D being substantially equal to the diameter 480D of the intermediate casing 480. The first electrode connector 422 is fabricated from an electrically conductive material and comprises a plurality of apertures 423 having the same hole pattern as the first electrode elements 420. The diameter 423D of apertures 423 is substantially equal to the first electrode outer diameter 420D. Endcap 460 is fabricated from a non-electrically conductive material as illustrated in the partially cut-away view. The inner diameter 460D of endcap 460 is substantially equal to the outer diameter 480D of the intermediate casing 480. The first and the second gas inlet ports 464 and 484 are affixed to the endcap 460 and communicate with the internal volume of the endcap 460. A first and a second aperture 469 and 489 in the cylindrical sidewall of the endcap 460 enable the conductors 468 and 488 affixed to the electrical contacts 469A and 489A respectively, to maintain electrical communication with the first electrical connector 422 and intermediate casing 480.

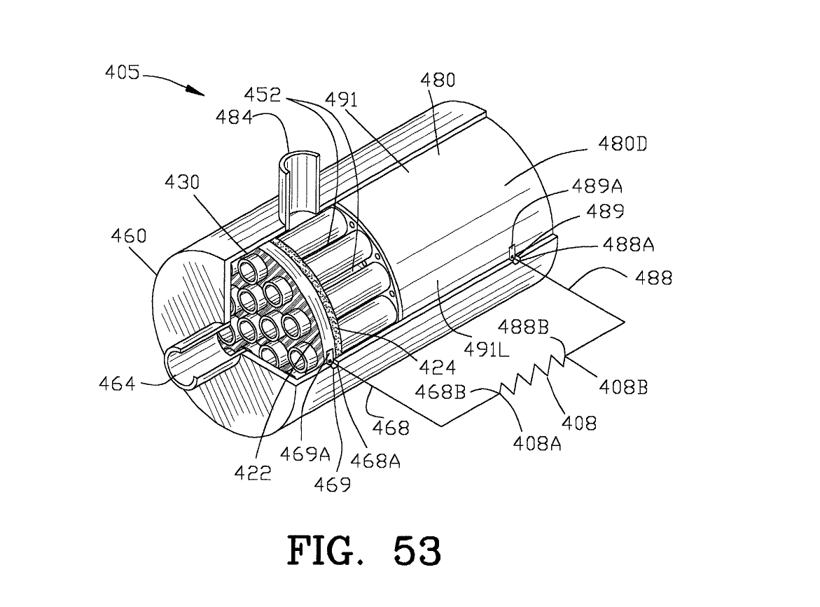

FIG. 53 is an partially cut-away isometric view illustrating the completed micro fuel cell array 405. Following the installation of the insulator 424 and the first electrode connector 420 on the first electrode elements 430, the endcap 460 is installed on the intermediate casing 480. A first electrical conductor 468 extends through end cap 460 via aperture 469 and is affixed at a first end 468A to the electrical contact 469A. The electrical contact 469A is in electrical communication with the first electrode connector 422. The first electrical conductor 468 is affixed at a second end 468B to a first end 408A of electrical load 408. A second electrical conductor 488 extends through end cap 460 via aperture 489 and is affixed at a first end 488A to electrical contact 489A. The electrical contact 489A is in electrical communication with the intermediate casing 480. The second electrical conductor 488 is affixed at a second end 488B to a second end 408B of load 408. When positioned as illustrated in FIG. 53, the endcap 460 with the first gas inlet port 464 thereon enables the first gas inlet port 464 to be in fluid communication with the internal volume of the endcap 460 and permit the first gas 406 to enter the first gas passageways 451. The endcap 460 with the second gas inlet port 484 thereon enables the second gas inlet port 484 to be in fluid communication with the internal volume of the endcap 460 and to permit the second gas 407 to enter the second gas passageways 452.

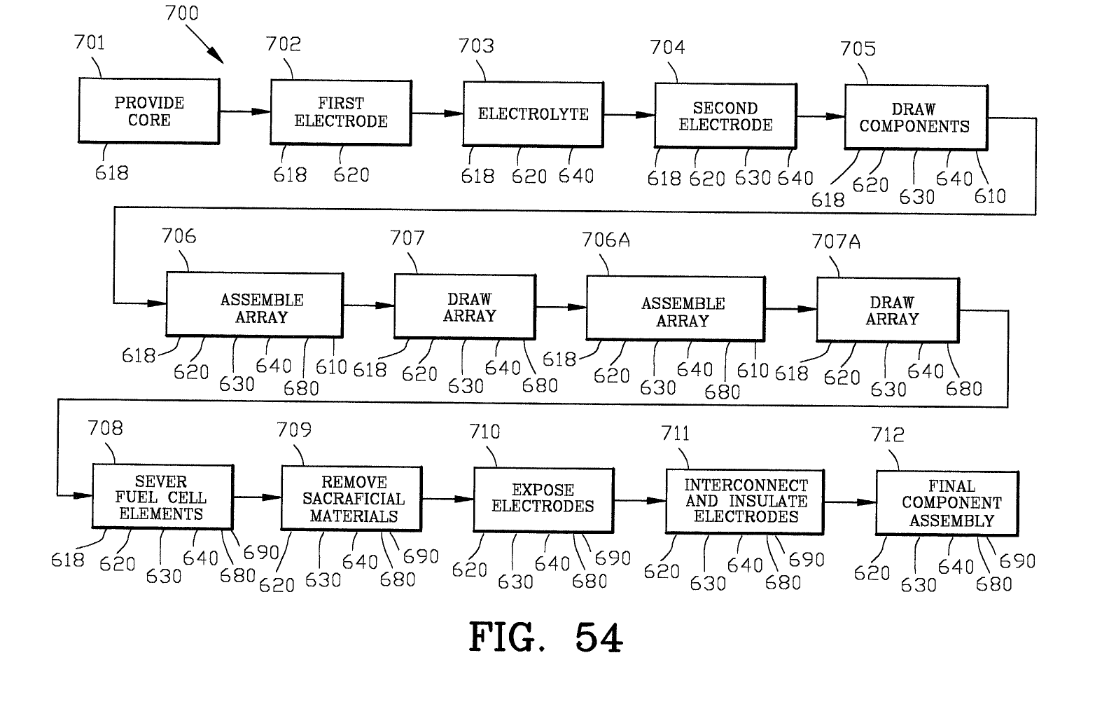

The fourth process 700 of making the micro fuel cell array 605 is shown in FIGS. 54-66. This process uses the same identification numbers used in the description of the first process increased by a factor of six hundred. The process 700 incorporates the use of a central sacrificial material 621 shown as a longitudinally extending sacrificial wire 621 disposed central to a strand formed from a plurality of fuel cell elements 615 within the cylindrical array 610. The sacrificial wire 621 may be a metallic wire such as a copper wire or the like. After removal of the sacrificial material 621, the longitudinally extending sacrificial wires 621 produces a void which acts as a second gas passageway 652 for allowing the second gas 607 to contact the second electrodes 630.

FIG. 54 is a block diagram illustrating the fourth process 700 of forming the micro fuel cell array 605 of the present invention. The process step of 701 to provide a core of sacrificial material 618, the process step 702 to cover the core of sacrificial material 618 with a first electrode material 620, the process step 703 to cover the first electrode 620 with an electrolyte material 640, the process step 704 to encase the electrolyte 640 with a second electrode material 630, and the process step 705 to draw the core of sacrificial material 618, first and second electrodes 620, 630 and the electrolyte 640 comprises the same process steps previously described in the first embodiment of the present invention as illustrated in FIG. 4 process steps 101-105.

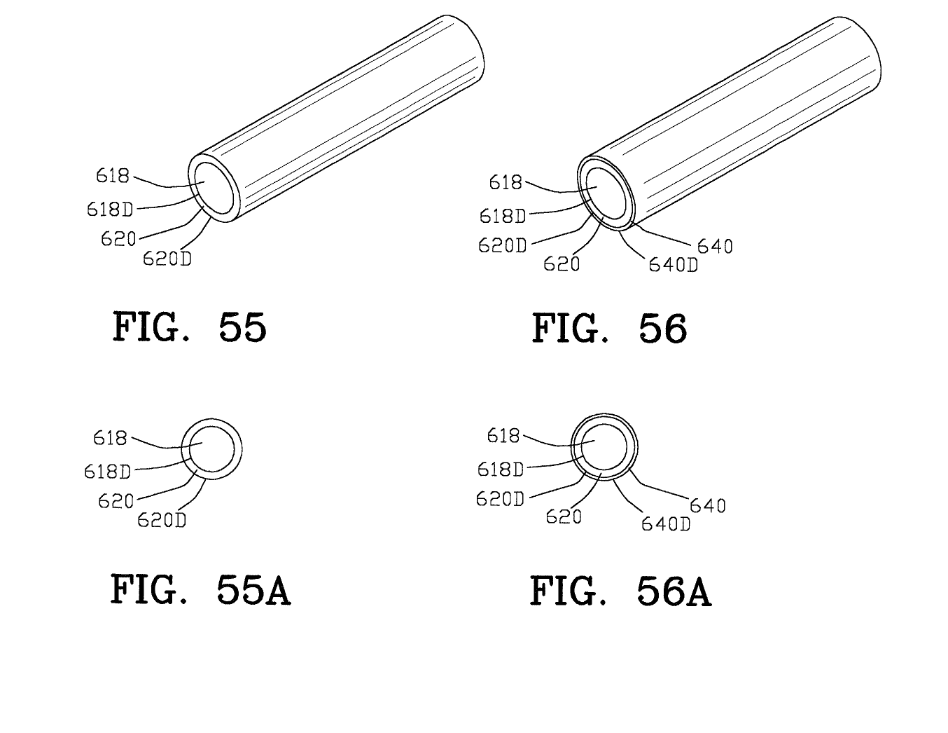

FIG. 55 illustrates process step 702 of FIG. 54, and is an isometric view of a first electrode element 620 encasing a sacrificial material 618. FIG. 55A is an end view of FIG. 55. Preferably, the first electrode element 620 comprises a material of high ductility and chemically 5 different from the sacrificial material 618.

FIG. 56 illustrates process step 703 of FIG. 54, and is an isometric view of an electrolyte material 640 covering the first electrode element 620 encasing a sacrificial material 618. FIG. 56A is an end view of FIG. 56. In one example of the invention the first electrode element 620 is inserted within a preformed tube made from the electrolyte material 640. In an alternative, the first electrode element 620 may be overlaid by bending a longitudinally extending sheet of electrolyte material 640 about the first electrode element 620. In another example of the invention, covering the first electrode element 620 includes coating the first electrode element 620 with the electrolyte material 640.

In an alternative, the process step 703 of covering the first electrode element 620 may include the application of a precursor electrolyte material 640 that is applied to cover the first electrode element 620. In a subsequent process step, the precursor electrolyte material 640 is subjected to a reaction whereby the precursor electrolyte material 640 is converted to an electrolyte material 640. Preferably, the electrolyte material 640 comprises a material of high ductility.

FIG. 57 illustrates process step 704 of FIG. 54, and is an isometric view of a second electrode 630 element encasing the electrolyte material 640 covering the first electrode element 620 encasing a sacrificial material 618. FIG. 57A is an end view of FIG. 57. As previously described relative to the first process, encasing the electrolyte material 640 with a second electrode element 630 may be accomplished in several ways depending on the physical and chemical characteristics desired in the micro fuel cell array 605. One example comprises the insertion of the coaxially assembled first sacrificial material 618, the first electrode 620 and electrolyte material 640 into a preformed tube made from the second electrode element 630 material. Another example is to cover the electrolyte material 640 by bending a longitudinally extending sheet of second electrode element 630 material about the electrolyte material 640. In another example, the second electrode element 630 material may be coated over the electrolyte material 640. In the alternative, the second electrode element 630 material may be electroplated onto the electrolyte material 640. Preferably, the second electrode element 630 comprises a material of high ductility and chemically different from the first electrode element material.

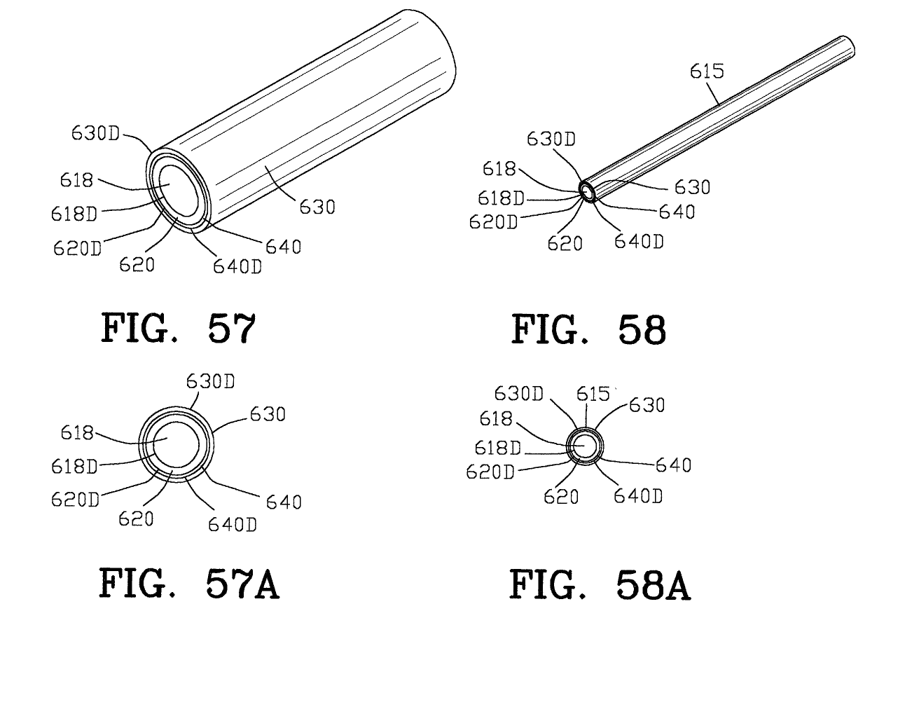

FIG. 58 is an isometric view after drawing the first and second electrode elements 620 and 630 and the electrolyte material 640 of FIG. 57. FIG. 58 illustrates process step 705 of FIG. 54, and is an isometric view of the first and second electrode elements 620, 630 and electrolyte 640 after drawing for forming a fuel cell element 615. FIG. 58A is an end view of FIG. 58. Preferably, the process step 705 of drawing the first and second electrode elements 620, 630 and electrolyte 640 and the first sacrificial material 618 includes a series of successive drawing and annealing steps.

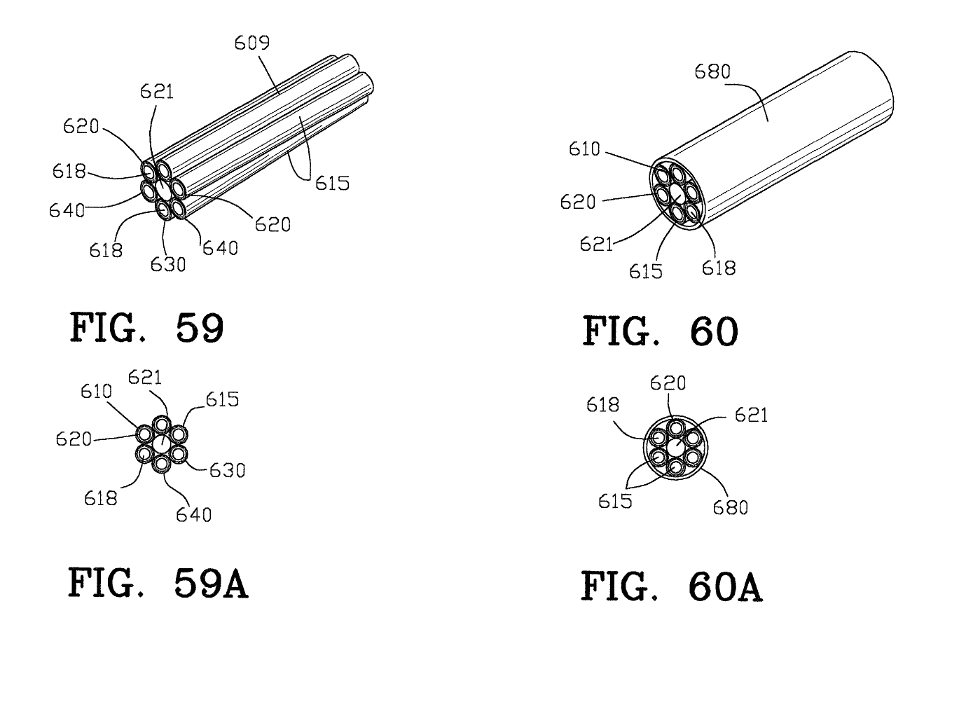

FIG. 59 illustrates the process step 706 of assembling the substantially cylindrical array 610 of fuel cell elements 615 and the central sacrificial materials 421. FIGS. 59 and 60 illustrates process step 706 of FIG. 54, and FIGS. 59A and 60A are end views of FIGS. 59 and 60 respectively.

FIG. 59 is an isometric view of the array of fuel cell elements 615 of FIG. 58 arranged in a cylindrical array 610 surrounding a central sacrificial material 621. The central sacrificial material 621 may comprise a metallic wire such as a copper wire or the like. A spiral twist 609 may be placed in the fuel cell elements 615 wound about central sacrificial material 621 to facilitate further processing.

FIGS. 60 is an isometric view of the array 610 of fuel cell elements 615, including the central sacrificial wire 621 of FIG. 59 bundled and encased in a tubular intermediate casing 680. Preferably, the intermediate casing 680 is a continuous electrically conductive tube having the same or similar properties as the second electrode elements 630.

FIG. 54 illustrates process step 707 of drawing the cylindrical array 610 of fuel cell elements 615 including the central sacrificial wire 621.

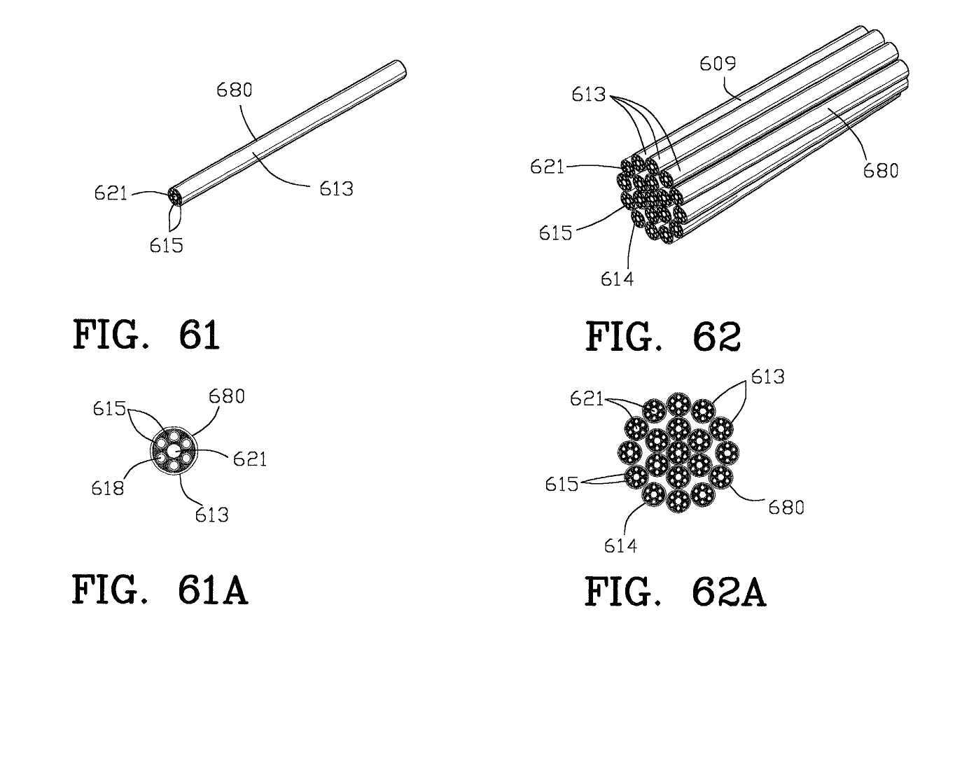

FIG. 61 is an isometric view of the encased array 610 of fuel cell elements 615 and the central sacrificial wire 621 of FIG. 60 after drawing. FIG. 61A is an end view of FIG. 61. The process step 707 of drawing the intermediate casing 680 with the fuel cell elements 615 and central sacrificial wire 621 therein forms a fuel cell member strand 613 and may include successive steps of drawing and annealing. The drawing process step 707 has the effect of moving the first electrode element 620 and the second electrode element 630 into engagement with opposed sides of the electrolyte material 640 forming the coaxial fuel cell element 615 thereby. The drawing process further comprises a reduction in diameter of the intermediate casing 680 and subsequent compression, elongation and cross-sectional deformation of the cylindrical array 610 of fuel cell elements 615 and the central sacrificial wire 621. During the drawing process, the second electrode elements 630 of the fuel cell elements 615 are moved into mutual engagement and fill the available internal volume of intermediate casing 680.

FIG. 54 illustrates process step 706A assembling an array 614 of fuel cell member strands 613 of FIG. 61.

FIG. 62 is an isometric view of the fuel cell member strands 613 of FIG. 61 arranged in a cylindrical array 614. FIG. 62A is an end view of FIG. 62. A spiral twist 609 is imparted to the array 614 to facilitate further processing.

FIGS. 63 is an isometric view of the array 614 of fuel cell member strands 613 of FIG. 62 5 bundled and encased in a tubular fuel cell casing 681. FIG. 63A is an end view of FIG. 63. Preferably, the fuel cell casing 681 is a continuous electrically conductive tube.

FIG. 54 illustrates process step 707A of drawing the array 614 of the fuel cell member strands 613 of FIG. 63.

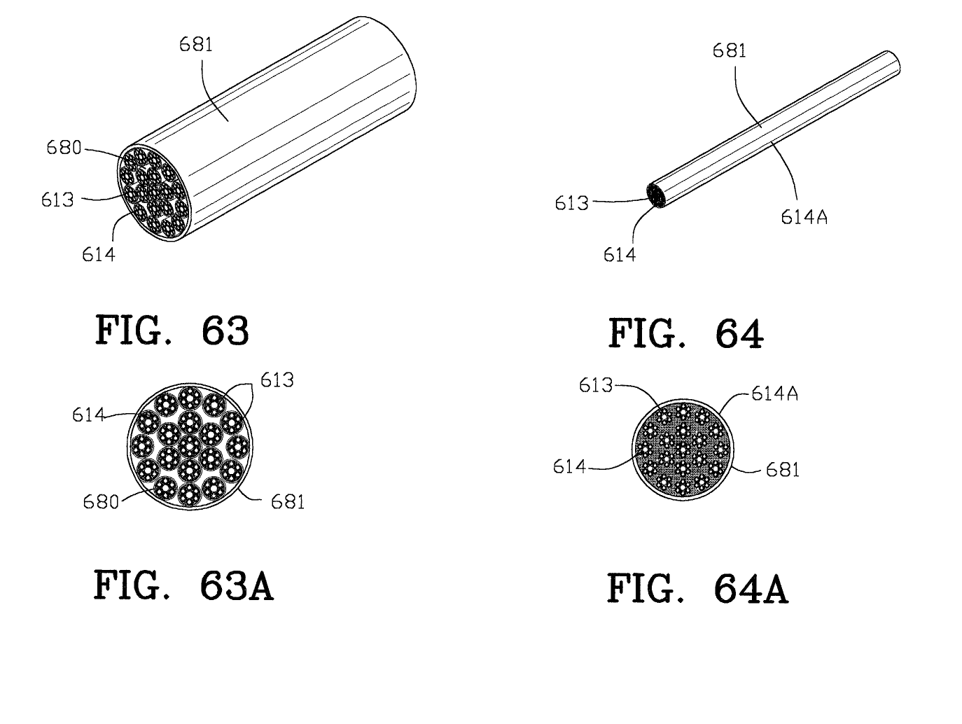

FIG. 64 is an isometric view of the array 614 of fuel cell member strands 613 of FIG. 62 after drawing. FIG. 64A is an end view of FIG. 64. The process step 707A of drawing the fuel cell casing 681 with the fuel cell member strands 613 therein forms a final array 614A and may include successive steps of drawing and annealing. The drawing process step 707A has the effect of moving each of the fuel cell member strands 613 into engagement with the adjacent fuel cell member strands 613. The drawing process further comprises a reduction in diameter of the fuel cell casing 681 and subsequent compression, elongation and cross-sectional deformation of the array 614 of fuel cell member strands 613. During the drawing process, the fuel cell member strands 613 are moved into mutual engagement and fill the available internal volume of the fuel cell casing 681.

FIG. 54 illustrates process step 708 of severing the drawn the fuel cell casing 681 with the fuel cell member strands 613 therein for enabling the removal of the sacrificial material 18.

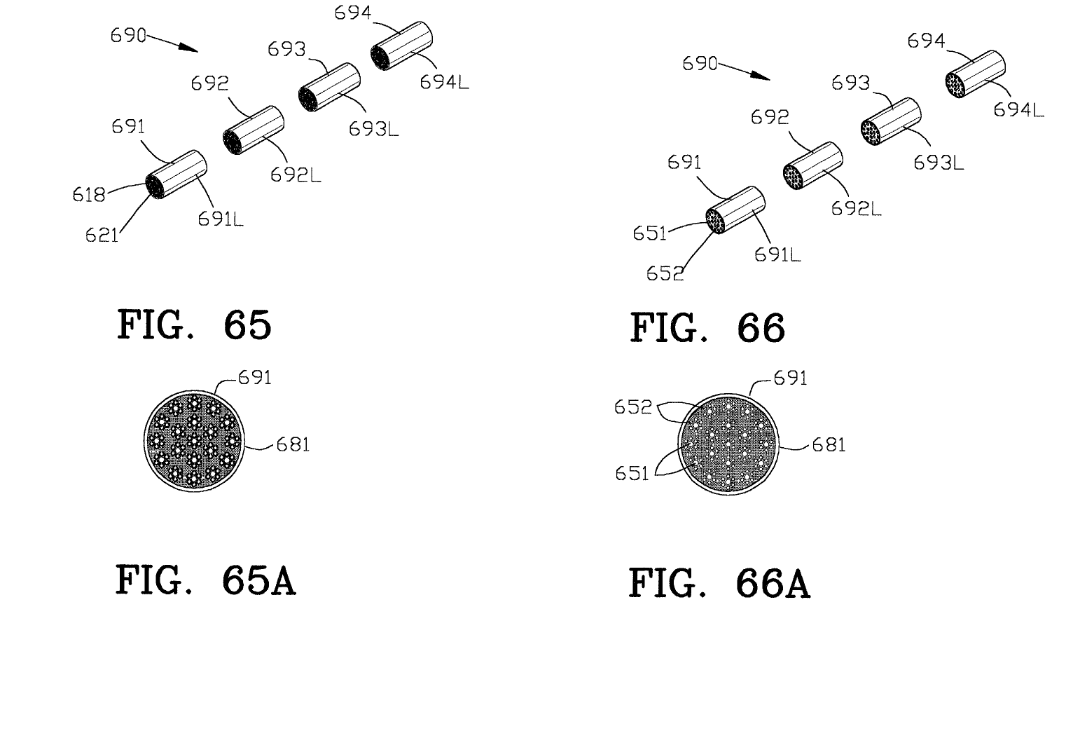

FIG. 65 is an isometric view of the severing of the final array 614A to form drawn fuel cell segments 690. FIG. 65A is an end view of FIG. 65. The drawn final array 614A comprising the fuel cell casing 680 with the multiplicity of fuel cell member strands therein is severed into segments 691-694 having a length 691L-694L for enabling the removal of the first sacrificial material 618 and the central sacrificial material 621. The lengths 691L-694L are sufficiently small for enabling the complete removal of the first sacrificial material 618 and the central sacrificial material 621 for providing the first and second gas passageways 651 and 652 respectively, while being sufficiently long to obtain the desired performance of the fully assembled micro fuel cell array 605.

FIG. 54 illustrates process step 709 removing the first sacrificial material 618 comprising the core and the central sacrificial material 621.

FIG. 66 is an isometric view of the chemical removal of the sacrificial material 618 and the central sacrificial material 621 from the severed fuel cell segments 691-694. FIG. 66A is an end view of FIG. 66. The chemical chosen for the dissolution and removal of the sacrificial material 618 and the central sacrificial material 621 is substantially chemically inert to and exhibits no substantial deleterious effects on the first and the second electrode elements 620 and 630, the electrolyte material 640, the fuel cell casing 681.

FIG. 54 illustrates process steps 710, 711, and 712, to expose the first and second electrodes, to interconnect and insulate the electrodes, and for final component assembly.

Exposure of the ends and electrodes of the micro fuel cell 605 as well as provision for the first and second gases 606 and 607, and first and second electrical conductors 668 and 688, are constructed and assembled using the methods and apparatus previously described.

The foregoing has described in an apparatus and process for making a micro fuel cell array incorporating the present invention. The process of making the micro fuel cell array has been described in three distinct and independent processes. The present disclosure includes that contained in the appended claims as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

What is claimed is:

1. A micro fuel cell array for providing electrical power to an electrical load upon flow of a first and a second gas, comprising:
a multiplicity of fuel cell elements formed into an array;
each of said multiplicity of said fuel cell elements comprising a first electrode element surrounded by a second electrode element with an electrolyte material interposed therebetween;
a first gas passageway proximate said first electrode element for allowing the first gas to flow therethrough and for allowing the first gas to interact with said first electrode element;
a second gas passageway proximate said second electrode element for allowing the second gas to flow therethrough and for allowing the second gas to interact with said second electrode element;
a first electrode element connector interconnecting each of said multiplicity of first electrode elements to form a first fuel cell electrode for connection to the electrical load; and
a second electrode element connector interconnecting each of said multiplicity of second electrode elements to form a second fuel cell electrode for connection to the electrical load.

2. A micro fuel cell array as set forth in claim 1, wherein each of said first electrode elements comprises a tube.

3. A micro fuel cell array as set forth in claim 1, wherein each of said first electrode elements is formed from a platinum material.

4. A micro fuel cell array as set forth in claim 1, wherein each of said first electrode elements is formed from a silver material.

5. A micro fuel cell array as set forth in claim 1, wherein each of said first electrode elements is formed from a gas permeable material.

6. A micro fuel cell array as set forth in claim 1, wherein said electrolyte material is formed from a ceramic material.

7. A micro fuel cell array as set forth in claim 1, wherein said electrolyte material is formed from a glass material.

8. A micro fuel cell array as set forth in claim 1, wherein said electrolyte material is formed from a polymeric material.

9. A micro fuel cell array as set forth in claim 1, wherein each of said second electrode elements includes a continuous metallic tube formed about each of said electrolyte material.

10. A micro fuel cell array as set forth in claim 1, wherein each of said second electrode elements is formed from a platinum material.

11. A micro fuel cell array as set forth in claim 1, wherein each of said second electrode elements is formed from a palladium material.

12. A micro fuel cell array as set forth in claim 1, wherein each of said second electrode elements is formed from a gas permeable material.

13. A micro fuel cell array as set forth in claim 1, wherein said first gas comprises oxygen and said second gas comprises hydrogen.

14. A micro fuel cell array as set forth in claim 1, wherein said first electrode element connector includes each of said first electrode elements having an exposed portion; and
said first electrode element connector interconnecting each of said exposed portions of each of said multiplicity of said first electrode elements to form said first fuel cell electrode for connection to the electrical load.

15. A micro fuel cell array for providing electrical power to an electrical load upon flow of a first and a second gas, comprising:
a multiplicity of fuel cell elements forming an array;
each of said multiplicity of said fuel cell elements comprising a first electrode element surrounded by a second electrode element with an electrolyte material interposed therebetween;
a first gas passageway proximate said first electrode element for allowing the first gas to flow therethrough and for allowing the first gas to electrochemically interact with said first electrode element;
a second gas passageway proximate said second electrode element for allowing the second gas to flow therethrough and for allowing the second gas to electrochemically interact with said second electrode element;
a first electrode element connector interconnecting each of said multiplicity of first electrode elements to form a first fuel cell electrode for connection to the electrical load; and
a second electrode element connector interconnecting each of said multiplicity of second electrode elements to form a second fuel cell electrode for connection to the electrical load; and
said second electrode element connector including said multiplicity of fuel cell elements being disposed within an electrically conductive casing for connection to the electrical load.

16. A micro fuel cell array as set forth in claim 1, wherein said array of said multiplicity of fuel cell elements being disposed in a cylindrical array.

17. The process for making a micro fuel cell array, comprising the steps of:
providing a multiplicity of fuel cell elements with each of the fuel cell element comprising a first electrode element overlaid by a second electrode element with an electrolyte material interposed therebetween; encasing the multiplicity of fuel cell elements within a casing;
drawing the casing with the multiplicity of fuel cell elements therein for reducing the outer diameter thereof and for electrically interconnecting the multiplicity of second electrode elements to form a second fuel cell electrode for connection to the electrical load; and
interconnecting the multiplicity of first electrode elements of the multiplicity of fuel cell elements to form a first fuel cell electrode for connection to the electrical load.

18. The process for making a micro fuel cell array, comprising the steps of:
providing a multiplicity of fuel cell elements with each of the fuel cell element comprising a first electrode element overlaid by a second electrode element with an electrolyte precursor material interposed therebetween; encasing the multiplicity of fuel cell elements within a casing;
drawing the casing with the multiplicity of fuel cell elements therein for reducing the outer diameter thereof and for electrically interconnecting the multiplicity of second electrode elements to form a second fuel cell electrode for connection to the electrical load; and
interconnecting the multiplicity of first electrode elements of the multiplicity of fuel cell elements to form a first fuel cell electrode for connection to the electrical load.

19. The process for making a micro fuel cell array as set forth in claim 18, including the step of converting the electrolyte precursor material into an electrolyte material.

20. The process for making a micro fuel cell array as set forth in claim 18, wherein the step of replacing the electrolyte precursor material with an electrolyte material.

21. The process for making a micro fuel cell array, comprising the steps of:
providing a sacrificial material;
covering the sacrificial material with a first electrode element;
covering the first electrode element with an electrolyte material;
encasing the electrolyte material with a second electrode element to form a fuel cell element;
drawing the first fuel cell element for reducing the outer diameter thereof;
encasing a multiplicity of fuel cell elements within a casing;
drawing the casing with the multiplicity of fuel cell elements therein for reducing the outer diameter thereof, and for forming a fuel cell and for electrically interconnecting the multiplicity of second electrode elements to form a second fuel cell electrode for connection to the electrical load;
removing the sacrificial material for providing a first gas passageway; and
interconnecting the multiplicity of first electrode elements of the multiplicity of fuel cell elements to form a first fuel cell electrode for connection to the electrical load.

22. The process for making a micro fuel cell array as set forth in claim 21, wherein the step of providing a sacrificial material includes providing a sacrificial material in the form of a metallic wire.

23. The process for making a micro fuel cell array as set forth in claim 21, wherein the step of providing a sacrificial material includes providing a sacrificial material in the form of a metallic wire having a substantially circular cross-section.

24. The process for making a micro fuel cell array as set forth in claim 21, wherein the step of providing a sacrificial material includes providing a sacrificial material in the form of a copper wire.

25. The process for making a micro fuel cell array as set forth in claim 21, wherein the step of covering the sacrificial material with a first electrode element comprises electroplating the first electrode element on the sacrificial material.

26. The process for making a micro fuel cell array as set forth in claim 21, wherein the step of covering the sacrificial material with a first electrode element comprises encasing the sacrificial material in a first metallic tube.

27. The process for making a micro fuel cell array as set forth in claim 21, wherein the step of covering the sacrificial material with a first electrode element includes forming a continuous tube around the sacrificial material.

28. The process for making a micro fuel cell array as set forth in claim 21, wherein the step of covering the first electrode element with an electrolyte material comprises:
applying an electrolyte precursor material to the first electrode element; and
chemically reacting the electrolyte precursor material to form an electrolyte material.

29. The process for making a micro fuel cell array as set forth in claim 21, wherein the step of encasing the electrolyte material with a second electrode element comprises electroplating the second electrode element on the electrolyte material.

30. The process for making a micro fuel cell array as set forth in claim 21, wherein the step of encasing the electrolyte material with a second electrode element comprises encasing the electrolyte material within a tube.

31. The process for making a micro fuel cell array as set forth in claim 21, wherein the step of encasing the electrolyte material with a second electrode element includes forming a continuous tube around the electrolyte material.

32. The process for making a micro fuel cell array as set forth in claim 21, wherein the step of encasing a multiplicity of fuel cell elements within a casing includes forming a parallel array of a multiplicity of fuel cell elements; and
encasing the array of a multiplicity of fuel cell elements within a preformed tube.

33. The process for making a micro fuel cell array as set forth in claim 21, wherein the step of encasing a multiplicity of fuel cell elements within a casing includes forming a continuous tube about the multiplicity of fuel cell elements.

34. The process for making a micro fuel cell array as set forth in claim 21, wherein the step of encasing the electrolyte material with a second electrode element includes encasing the electrolyte material within a tube having different chemical properties than the chemical properties of the first electrode element.

35. The process for making a micro fuel cell array as set forth in claim 21, wherein the step of drawing the casing with the multiplicity of fuel cell elements therein electrically interconnects the multiplicity of second electrode elements and the casing for forming a second fuel cell electrode for connection to the electrical load.

36. The process for making a micro fuel cell array as set forth in claim 21, wherein the step of removing the sacrificial material for providing a first gas passageway comprises chemically etching the sacrificial material.

37. The process for making a micro fuel cell array as set forth in claim 21, wherein the step of interconnecting the multiplicity of first electrode elements to form a first fuel cell electrode comprises exposing a portion of each of the multiplicity of first electrode elements of fuel cell elements; and
interconnecting the exposed portion of each of the multiplicity of the first electrode elements of fuel cell elements to form a first fuel cell electrode for connection to the electrical load.
